(19) United States
(12) Patent Application Publication
(10) Pub. No.: US 2015/0219300 A1
(43) Pub. Date: Aug. 6, 2015

(54) LIGHT SOURCE FOR HEAD LIGHT AND HEAD LIGHT

(71) Applicants: Naohiro Kishi, Tokyo (JP); Fumihiro Minami, Tokyo (JP); Takashi Ohsawa, Tokyo (JP)

(72) Inventors: Naohiro Kishi, Tokyo (JP); Fumihiro Minami, Tokyo (JP); Takashi Ohsawa, Tokyo (JP)

(73) Assignee: MITSUBISHI ELECTRIC CORPORATION, Tokyo (JP)

(21) Appl. No.: 14/419,444

(22) PCT Filed: Aug. 28, 2012
(86) PCT No.: PCT/JP2012/071689

§ 371 Date: Feb. 3, 2015

(51) Int. Cl. F21S 8/10

(52) U.S. Cl. CPC F21S 48/1241; F21S 48/1317; F21S 48/1225; F21S 48/145; F21S 48/1159; F21W 2101/10

(57) ABSTRACT

In a projector-type headlight in which a light-emitting face of an LED 1 is placed perpendicular to an optical axis so that light emitted by the LED 1 is projected ahead of a vehicle through a convex lens 2, the light-emitting face is placed upward from the optical axis of the headlight, and a lower edge side 1a of the light-emitting face is formed into a linear shape and is placed on the optical axis, and a reflection face 3a is placed in a plane formed by the optical axis and the linear-shape edge side 1a of the LED 1 to thereby combine direct light emitted by the LED 1 and reflection light reflected on the reflection face 3a, so that an intensity of light emitted in a direction normal to the light-emitting face from the edge side 1a is enhanced.

### TECHNICAL FIELD

This invention relates to a light source for headlight of projector-type which projects light emitted from a light-emitting face placed perpendicular to an optical axis of a headlight, ahead of a vehicle through a convex lens, and a headlight using the light source for headlight.

### BACKGROUND ART

Nowadays, as optical sources for in-vehicle headlight (for driving light, passing light, etc.), LEDs have become popular in place of conventional tungsten-filament lamps or arc discharge-based discharge lamps. These LEDs are long-life and can surely achieve required brightness with lower power, and further, can emit to provide stable brightness under easy control that makes constant a current supplied thereto. Thus, they are preferred as optical sources of lamp devices for in-vehicle use.

In the followings, conventional examples are shown about a projector-type headlight including an LED as an optical source in which a light-emitting face of the LED is placed perpendicular to the optical axis of the headlight.

A vehicle headlight according to Patent Document 1 has a configuration in which a plurality of LEDs are mounted on a ceramic board so that a light-dark separating line (cut-off line) by which a light portion and a dark portion are clearly separated at a boundary with a given height, is formed by an enveloping line of the LEDs. In FIG. 29 of Patent Document 1, there is shown a specific example of light distribution; however, a portion near the cut-off line is darker than a portion under the cut-off line, so that the cut-off line is unclear.

Meanwhile, a lamp assembly according to Patent Document 2 has a configuration in which: respective light emitted by a plurality of individually-separated optical sources are mixed so that each light is introduced in a region between adjacent two optical sources and thus a dark portion is brightened, to thereby mitigate a light-dark difference in the illumination light; and a shield is provided for forming a boundary (cut-off line) between light and dark portions in vertical direction. Note that in claim 4 of Patent Document 2, there is a description that the upper face of the shield is reflective.

Meanwhile, an illumination device for automobile according to Patent Document 3 has a configuration in which a low beam (passing light) and a high beam (driving light) are formed by appropriately lighting up each of plural LEDs arranged in matrix form. Note that in the paragraph [0016] of Patent Document 3, there is a description that a region in front of the automobile is monitored so as in particular to detect an oncoming traveler, and the LEDs are controlled according to information that specifies the traveler's position.

### PRIOR ART DOCUMENTS

### Patent Documents

Patent Document 1: Japanese Patent Application Laid-open No. 2009-87681

Patent Document 2: Japanese National Publication of International Patent Application No. 2011-518716

Patent Document 3: Japanese Patent Application Laid-open No. 2010-40528

### SUMMARY OF THE INVENTION

### Problems to be Solved by the Invention

FIG. 34 is a diagram showing a light distribution of an LED 1 with no particular optical member whose light-emitting face is nearly planar, in which illustrated is a light-intensity distribution in up-down direction (vertical direction) as viewed from the lateral side of the LED 1. Illustrated in FIG. 35 is a light-intensity distribution in left-right direction (horizontal direction) as viewed from above the LED 1. Further, in FIG. 36 and FIG. 37, there is shown a case where the light-emitting face of the LED 1 shown in FIG. 34 is placed orthogonal to an optical axis of headlight to be used as a light source of a projector-type headlight that projects light emitted from the light-emitting face of the LED 1 ahead of a vehicle through a convex lens 2. Illustrated at FIG. 36 (a) is a side view along an up-down direction (vertical direction) of an optical system of a projector-type passing headlight, as viewed from the lateral side of the LED 1, and at FIG. 36(b) is a condition of illumination light radiated ahead of the vehicle. Illustrated at FIG. 37 (b) is a plan view along a left-right direction (horizontal direction) of an optical system for the projector-type passing headlight, as viewed from above the LED 1, and at FIG. 37(b) is a condition of illumination light radiated ahead of the vehicle. In these FIG. 36 (b) and FIG. 37 (b), brightness of the illumination light is indicated by shading, so that a bright portion of the illumination light is deeply depicted and a dark portion thereof is lightly depicted.

Note that a positional relationship between FIG. 36(a) and FIG. 36 (b) and a positional relationship between FIG. 37 (a) and FIG. 37 (b) will be described in the following Embodiment 1 with reference to FIG. 5, so that they are not detailed here. Further, “blurred light corresponding to radius of convex lens” in FIG. 36 will be described in the following Embodiment 1 with reference to FIG. 6, so that it is not detailed here.

Since the LED 1 emits light from a planar face (light-emitting face) of a semiconductor chip, an intensity of light emitted in a direction normal to the light-emitting face is higher at a central portion of the light-emitting face, but is lower at a periphery portion in particular at an edge side 1a of the light-emitting face, as shown in FIG. 34. Accordingly, if a cut-off line (light-dark boundary line across up-down direction of the illumination light) for passing light is formed according to the shape of the edge side 1a of the light-emitting face (boundary line for emission by an optical source), a portion near the light-dark boundary line i.e. the cut-off line becomes darker and a portion apart from the cut-off line becomes brighter, as shown in FIG. 36 (maximum illuminance point in FIG. 36(b) and FIG. 37(b)). Thus, there is a problem that the brightest portion is shifted downward from the cut-off line, so that the illuminance near the cut-off line is low, and thus the cut-off line becomes unclear.

Referring to FIG. 29 of Patent Document 1, a portion near the cut-off line is darker than a portion under the cut-off line, so that the cut-off line is unclear.

Namely, in the light distribution of the headlight, the road surface in front of the vehicle is conventionally brighter than a distant area therefrom. However, even in the case of passing light, brightness is required for the distant area, and thus it is desirable to brightly illuminate near the cut-off line. For that purpose, it would be required for the headlight with the configuration as shown in FIG. 36 and FIG. 37 to take a measure of adjusting the intensity distribution of light emitted by the light-emitting face of the LED 1 so as to enhance the light intensity at the edge side 1a so that the illuminance near the cut-off line is made higher. However, in any of the above Patent Documents 1 to 3, there is no description about a concept of making higher the illuminance near the cut-off line for passing light.

Note that in Patent Document 2, there is described a configuration in which a mirror reflector is provided under an LED; however, the mirror reflector is placed away from the LED, so that a portion to be illuminated brightly is located apart from the cut-off line. Thus, like Patent Document 1, the brightest portion is shifted downward from the cut-off line, so that the illuminance near the cut-off line is dark, and thus the cut-off line becomes unclear.

This invention has been made to solve the problem as described above, and an object thereof is to provide a light source for headlight and a headlight, by which the illuminance near the cut-off line is made higher, so that the cut-off line is formed to be clear.

### Means for Solving the Problems

A light source for headlight of the invention is a light source for headlight which projects light emitted from a light-emitting face placed perpendicular to an optical axis of a headlight, ahead of a vehicle through a convex lens, comprising: an optical source provided with the light-emitting face whose edge side is formed into a linear shape and is placed on the optical axis or near the optical axis; and a reflection face that is provided in a plane formed by a line parallel to the optical axis and a line parallel to the linear edge side of the light-emitting face and placed between the optical axis and the light-emitting face, and that reflects the light emitted from the optical source.

Another light source for headlight of the invention is a light source for headlight which projects light emitted from a light-emitting face placed perpendicular to an optical axis of a headlight, ahead of a vehicle through a convex lens, comprising: an optical source provided with the light-emitting face whose edge side is formed into a linear shape and placed apart from the optical axis; a reflection face that is provided in a plane formed by a line parallel to the optical axis and a line parallel to the linear edge side of the light-emitting face and placed between the optical axis and the light-emitting face, and that reflects the light emitted from the optical source; and a light guide member provided between the refection face and the convex lens, that brings the light emitted from the light-emitting face, closer toward the optical axis.

Another light source for headlight of the invention is a light source for headlight which projects light emitted from a light-emitting face placed perpendicular to an optical axis of a headlight, ahead of a vehicle through a convex lens, comprising: an optical source provided with the light-emitting face whose edge side is formed into a linear shape and placed apart from the optical axis; and a light guide member that brings the light emitted from the light-emitting face, closer toward the optical axis; wherein the light guide member has a flat face corresponding to a plane that is formed by a line parallel to the optical axis and a line parallel to the linear edge side of the light-emitting face, and an inner side of the flat face is provided as a reflection face that reflects the light emitted from the optical source.

A headlight of the invention is that which uses the above described light source for headlight.

### Effect of the Invention

According to the invention, when the linear edge side of the optical source is placed on the optical axis or near the optical axis of the headlight and a mirror reflector is provided on the optical axis or near the optical axis, direct light emitted from the light-emitting face and reflection light reflected on the reflection face of the mirror reflector are combined with each other, so that an intensity of light emitted from the linear edge side of the optical source in the direction normal to the light-emitting face i.e. in a direction toward the center of the headlight along the optical axis, can be enhanced equivalently. Thus, it is possible to provide alight source for headlight capable of forming a clear cut-off line by brightly illuminating near the cut-off line, and a headlight that uses the light source for headlight.

According to the invention, when the linear edge side of the optical source is placed apart from the optical axis and the light guide member and the mirror reflector are provided, the linear edge side placed apart from the optical axis can be placed equivalently as if on the optical axis or near the optical axis, and thus direct light emitted from the light-emitting face and reflection light reflected on the reflection face of the mirror reflector are combined with each other, so that an intensity of light emitted from the linear edge side of the optical source in a direction toward the center of the headlight along the optical axis, can be enhanced equivalently. Thus, it is possible to provide a light source for headlight capable of forming a clear cut-off line by brightly illuminating near the cut-off line, and a headlight that uses the light source for headlight.

According to the invention, when the linear edge side of the optical source is placed apart from the optical axis and the light guide member having a mirror reflector function is provided, the linear edge side placed apart from the optical axis can be placed equivalently as if on the optical axis or near the optical axis, and thus direct light emitted from the light-emitting face and reflection light reflected on a reflection face of the light guide member are combined with each other, so that an intensity of light emitted from the linear edge side of the optical source in a direction toward the center of the headlight along the optical axis, can be enhanced equivalently. Thus, it is possible to provide a light source for headlight capable of forming a clear cut-off line by brightly illuminating near the cut-off line, and a headlight that uses the light source for headlight.

### BRIEF DESCRIPTION OF THE DRAWINGS

FIG. 1 is a cross-sectional view showing a configuration of a headlight according to Embodiment 1 of the invention.

FIG. 2 is a diagram showing a light distribution of an LED of Embodiment 1, in which illustrated is a light-intensity distribution in up-down direction (vertical direction) as viewed from the lateral side of the LED.

FIG. 3 is a diagram showing a light distribution of the LED of Embodiment 1, in which illustrated is a light-intensity distribution in left-right direction (horizontal direction) as viewed from above the LED.

FIG. 4 is a diagram showing a light distribution when LEDs are placed upward and downward from an optical axis.

FIG. 5 shows referential sizes of an optical system of the headlight according to Embodiment 1, in which shown at FIG. 5(a) is a side view illustrating a condition in up-down direction (vertical direction) as viewed from the lateral side of the LED and illustrated at FIG. 5(b) is a condition of illumination light as viewed frontward from an vehicle.

FIG. 6 is a diagram illustrating an optical system of the headlight according to Embodiment 1, in which illustrated at FIG. 6(a) is a side view as viewed from the lateral side of the LED and at FIG. 6(b) is illumination light in front of a vehicle.

FIG. 7 is a diagram illustrating the optical system of the headlight according to Embodiment 1, in which shown at FIG. 7(a) is a plan view illustrating a condition in left-right direction (horizontal direction) as viewed from above the LED and illustrated at FIG. 7(b) is illumination light in front of the vehicle.

FIG. 8 is a diagram showing a modified example of a convex lens of the headlight according to Embodiment 1.

FIG. 9A is a diagram showing a modified example of a convex lens of the headlight according to Embodiment 1, in which shown at FIG. 9A(a) is a side view illustrating an optical system as viewed from the lateral side of the LED, and illustrated at FIG. 9A(b) is illumination light in front of a vehicle.

FIG. 9B shows the headlight that uses the convex lens shown in FIG. 9A, in which shown at FIG. 9B(a) is a plan view illustrating an optical system as viewed from above the LED and illustrated at FIG. 9B(b) is illumination light in front of the vehicle.

FIG. 10 is a diagram illustrating an optical system of a headlight according to Embodiment 2 of the invention, in which illustrated at FIG. 10(a) is a side view as viewed from the lateral side of an LED and at FIG. 10(b) is illumination light in front of a vehicle.

FIG. 11 is a diagram illustrating an optical system of a headlight according to Embodiment 3 of the invention, in which illustrated at FIG. 11(a) is a side view as viewed from the lateral side of an LED and at FIG. 11(b) is illumination light in front of a vehicle.

FIG. 12 is an enlarged view of a mirror reflector and a light guide member in FIG. 11(a).

FIG. 13 is a diagram showing a modified example of the optical system of the headlight according to Embodiment 3.

FIG. 14 is an enlarged view of a mirror reflector and a light guide member in FIG. 13.

FIG. 15 is a diagram showing a modified example of the optical system of the headlight according to Embodiment 3.

FIG. 16 is a side view of an optical system of a headlight as viewed from its lateral side, according to Embodiment 4 of the invention.

FIG. 17 is a diagram showing a modified example of a light guide member of the headlight according to Embodiment 4.

FIG. 18 is a cross-sectional view showing a configuration of a headlight according to Embodiment 5 of the invention.

FIG. 19 is a side view of an optical system of a headlight as viewed from its lateral side, according to Embodiment 6 of the invention.

FIG. 20 is a diagram showing a modified example of the optical system of the headlight according to Embodiment 6.

FIG. 21 is a side view of an optical system of a headlight as viewed from its lateral side, according to Embodiment 7 of the invention.

FIG. 22 is a diagram illustrating a reference example in aid of understanding Embodiment 7 of the invention, in which shown is a side view as viewed from the lateral side of an LED.

FIG. 23 is a diagram illustrating an optical system of a headlight according to Embodiment 8 of the invention, in which shown at FIG. 23(a) is a plan view and at FIG. 23(b) is a side view.

FIG. 24 is a diagram showing a condition of illumination light radiated ahead of a vehicle, in the case where all LEDs of the headlight according to Embodiment 8 are lit up.

FIG. 25 is a diagram illustrating an optical system of a headlight according to Embodiment 9 of the invention, in which shown at FIG. 25(a) is a plan view and at FIG. 25(b) is a side view.

FIG. 26 is a diagram illustrating a positional relationship between a mirror reflector and partitioning mirror reflectors of the headlight according to Embodiment 9.

FIG. 27 is a diagram showing a condition of illumination light radiated ahead of a vehicle, in the case where a part of the headlight according to Embodiment 9 is lit off and the other part is lit up.

FIG. 28 is a circuit diagram of an LED lighting device that controls lighting of the headlight according to Embodiment 9.

FIG. 29 is a diagram illustrating a condition where light emitted by an oncoming vehicle enters into the optical system of the headlight according to Embodiment 9.

FIG. 30 is a diagram illustrating a modified example of the optical system of the headlight according to Embodiment 9, in which shown is a case of using light guide members instead of the partitioning mirror reflectors.

FIG. 31 is a diagram showing a modified example of the light guide members of the headlight according to Embodiment 9.

FIG. 32 is a diagram illustrating an optical system of the headlight that uses the light guide members shown in FIG. 31.

FIG. 33 is a cross-sectional view showing a configuration of a headlight according to Embodiment 10 of the invention.

FIG. 34 is a diagram showing a light distribution of a conventional LED, in which illustrated is a light-intensity distribution in up-down direction (vertical direction) as viewed from above the LED.

FIG. 35 is a diagram showing a light distribution of conventional LED, in which illustrated is the light-intensity distribution in left-right direction (horizontal direction) as viewed from the lateral side of the LED.

FIG. 36 shows a case where the LED in FIG. 34 is used as a light source for a projector-type headlight, in which shown at FIG. 36(a) is side view illustrating a condition of the optical system in up-down direction (vertical direction) as viewed from the lateral side of the LED, and illustrated at FIG. 36(b) is a condition of illumination light radiated ahead of an vehicle.

FIG. 37 shows a case where the LED in FIG. 34 is used as a light source for a projector-type headlight, in which shown at FIG. 37 (a) is a condition illustrating a condition of the optical system in left-right direction (horizontal direction) as viewed from above the LED, and illustrated at FIG. 37 (b) is a condition of illumination light radiated ahead of the vehicle.

### MODE FOR CARRYING OUT THE INVENTION

Hereinafter, for illustrating the invention in more detail, embodiments for carrying out the invention will be described according to the accompanying drawings.

### Embodiment 1

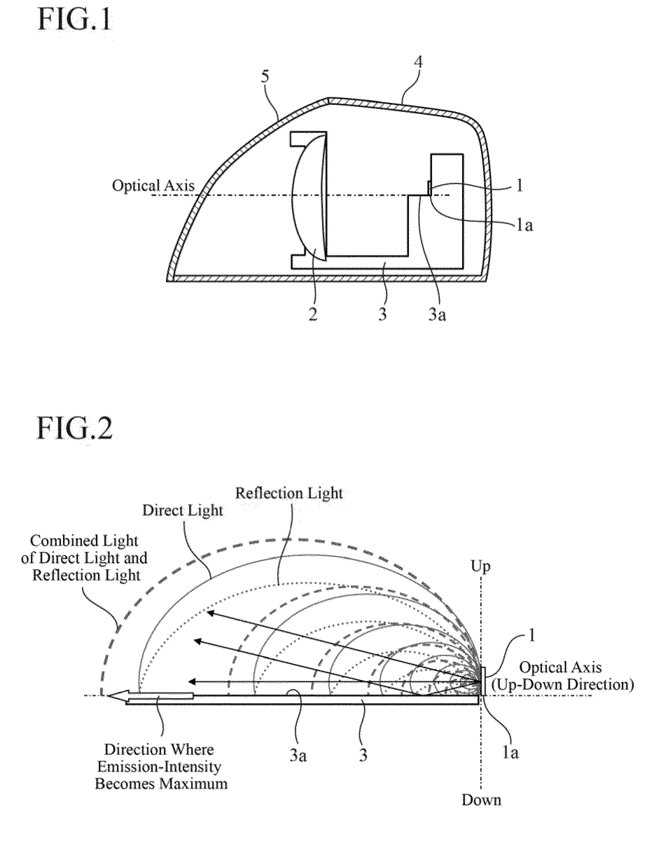

As shown in FIG. 1, a headlight according to Embodiment 1 is an example of a projector-type passing-purpose headlight, which includes: an LED (optical source) 1 with no particular optical member whose light-emitting face is nearly planar and is placed perpendicular to an optical axis of the headlight; a convex lens 2 that projects light emitted from the light emitting face of the LED 1 ahead of a vehicle; a mirror reflector 3 that serves as both a heat sink of the LED 1 and a support member of the convex lens 2; a casing 4 that accommodates an optical system developed by such LED 1, convex lens 2 and mirror reflector 3; and a front lens 5. The light-emitting face of the LED 1 is placed upward from the optical axis, and an edge side 1a of the light-emitting face in the optical axis-side is formed into a linear shape and placed on the optical axis. Further, a reflection face 3a of the mirror reflector 3 is placed in a plane formed by the edge side 1a of the light-emitting face and the optical axis.

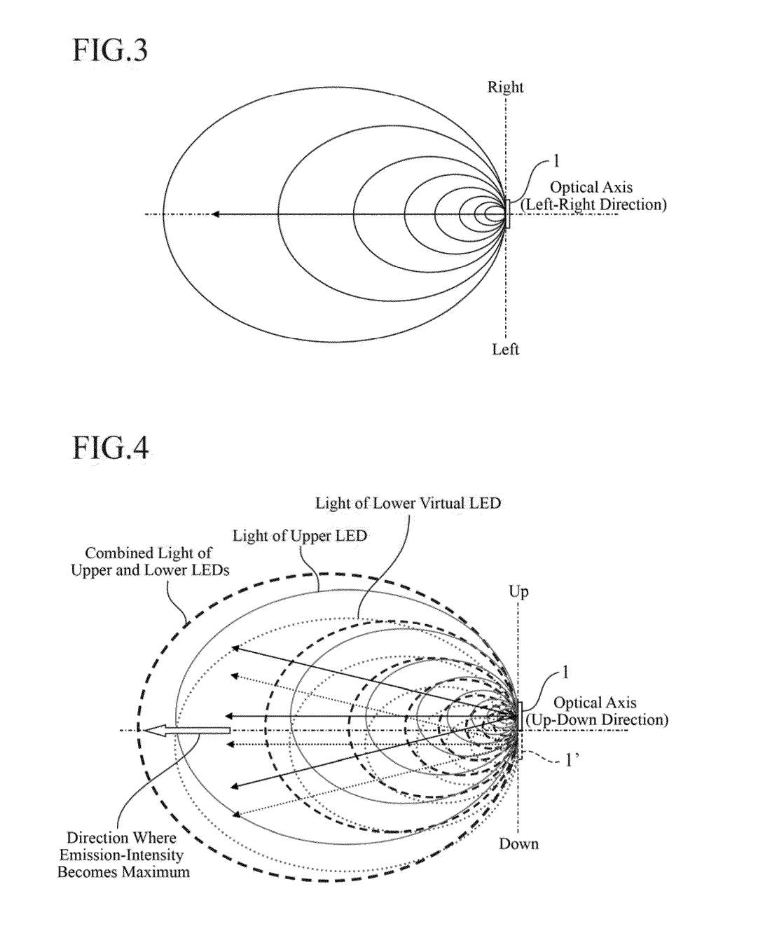

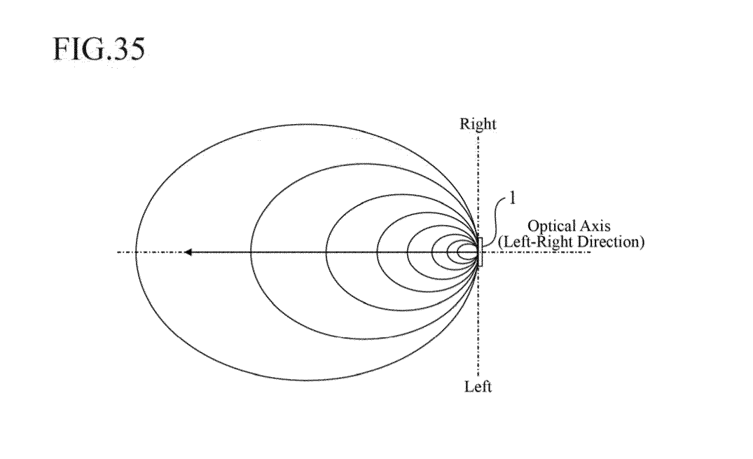

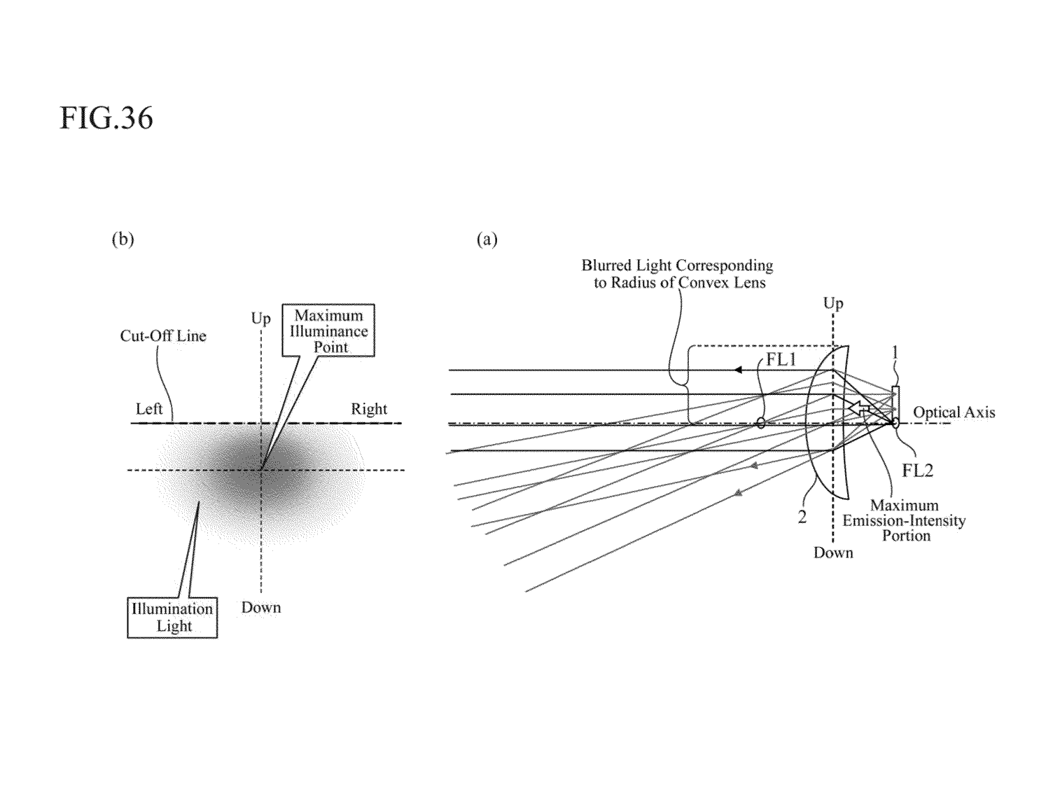

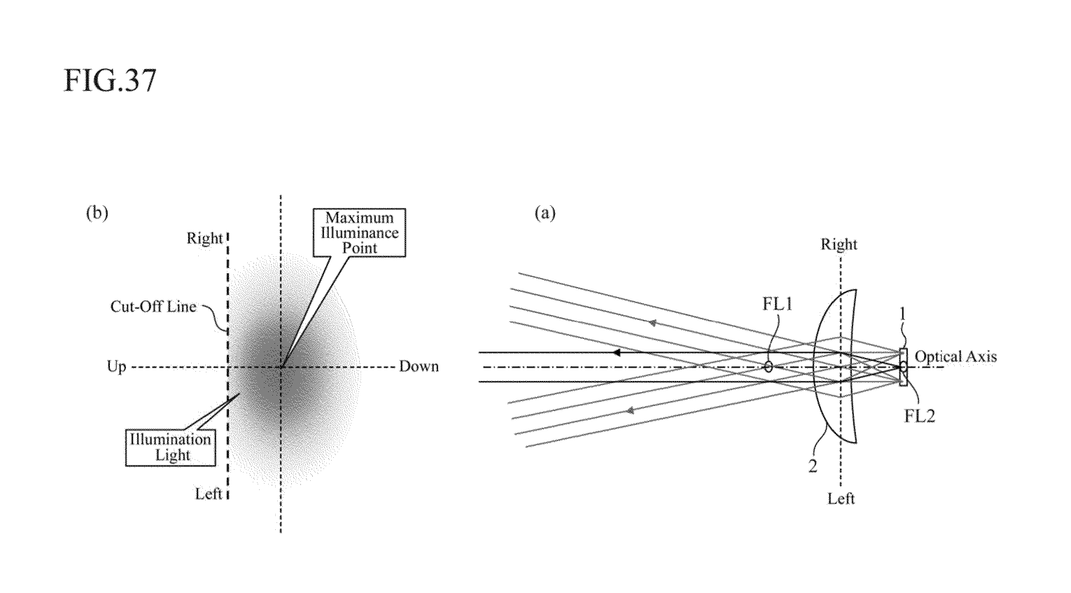

FIG. 2 is a diagram showing a light distribution of the LED 1, in which illustrated is a light-intensity distribution in up-down direction (vertical direction) as viewed from the lateral side of the LED 1. In FIG. 3, a light-intensity distribution in left-right direction (horizontal direction) as viewed from above the LED 1. Light emitted in a normal direction from the light-emitting face of the LED 1 (direct light indicated by an actual line in the figure) is brightest at the center of the light-emitting face. Thus, solely by the direct light, as shown in FIG. 34 to FIG. 37 described previously, a portion apart from the cut-off line is brightly illuminated, so that a portion near the cut-off line is dark, and thus the cut-off line becomes unclear.

Thus, the reflection face 3a is placed in proximity to the edge side 1a of the LED 1 as shown in FIG. 2, so that light reflected on the reflection face 3a (reflection light indicated by a dotted line in the figure) is combined with the direct light, to thereby produce combined light indicated by a broken line in the figure). Because of providing the reflection face 3a, as shown in FIG. 4, a configuration of the light radiated by the LED 1 to the upper side of the optical axis of the headlight becomes comparable to that of the upper-side light in the light emitted by an LED having a large light-emitting face configured with both the LED 1 and another LED 1′ in which the LED 1 is placed in the upper side of the optical axis and the LED 1′ is also placed in the lower side of the optical axis. Thus, it is possible to enhance the light emitted in a direction normal to the light-emitting face from the center of the LED having a large light-emitting face, namely, from the edge side 1a of the LED 1.

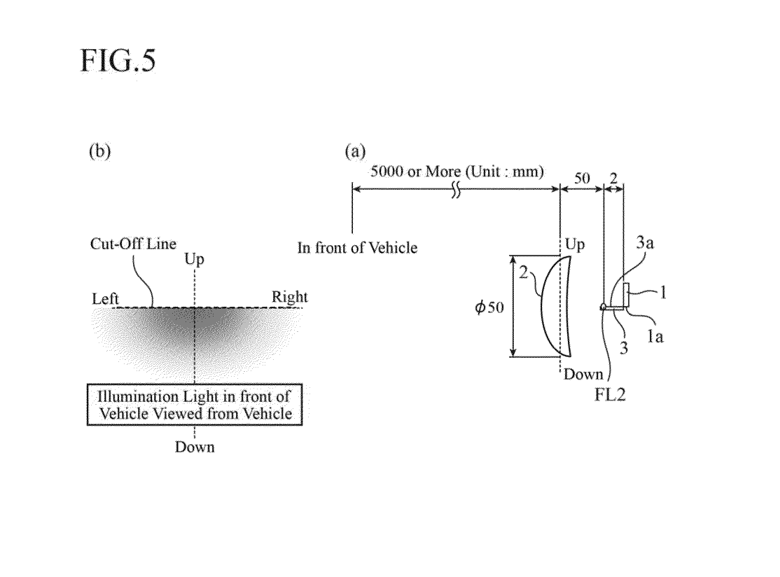

Here, in FIG. 5, reference sizes of the optical system of the headlight according to Embodiment 1 are shown. Illustrated at FIG. 5(a) is a condition of the optical system of the headlight shown in FIG. 1 in up-down direction (vertical direction) as viewed from the lateral side of the LED 1, and illustrated at FIG. 5(b) is a condition of illumination light irradiated ahead of the vehicle as viewed from the vehicle-side. Note that in the figures used for the description here, the brightness of the illumination light is indicated by shading, so that a bright portion of the illumination light is deeply depicted and a dark portion thereof is lightly depicted.

The LED 1 is placed at a position distant more than a focal length up to a rear focal point FL2 from the convex lens 2, and the edge side 1a of the LED 1 is arranged on an optical axis of the convex lens 2. Further, the mirror reflector 3 is placed between the rear focal point FL2 of the convex lens 2 and the light-emitting face of the LED 1, and the reflection face 3a of the mirror reflector 3 is arranged on the optical axis of the convex lens 2. Here, as an example, a distance from the light-emitting face of the LED 1 to the rear focal point FL2 of the convex lens 2 is given as 2 mm and the focal length of the convex lens 2 is given as 50 mm.

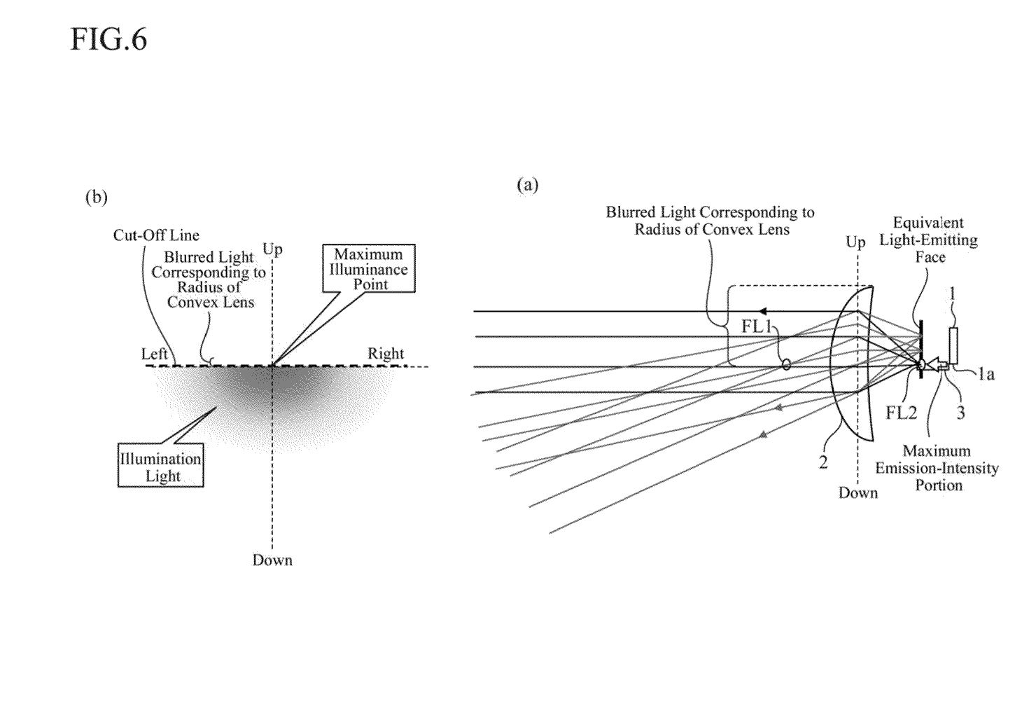

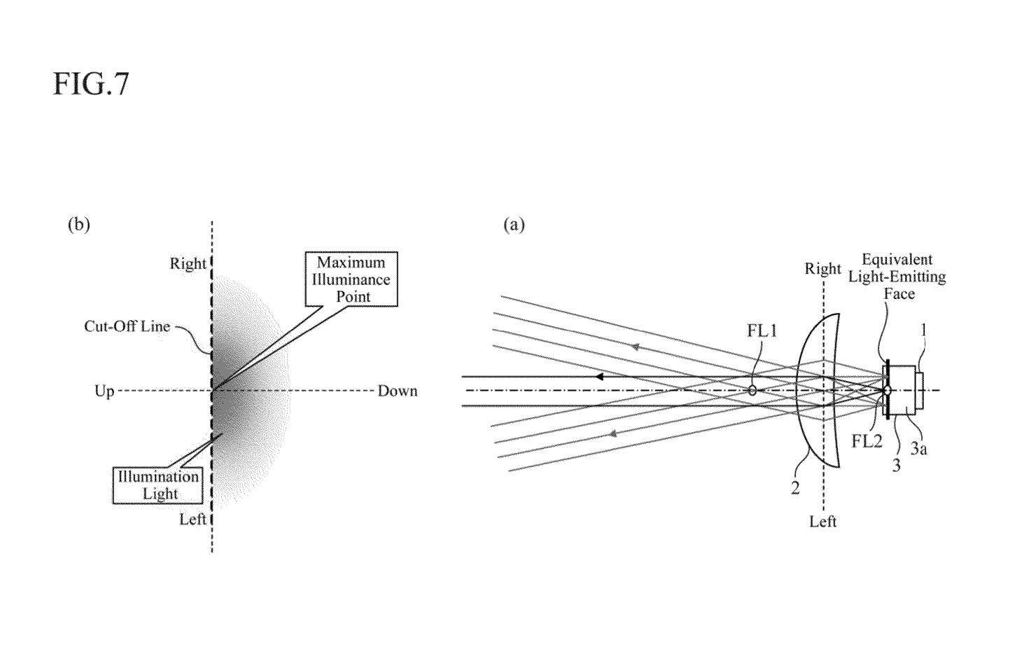

Illustrated at FIG. 6(a) is a condition of the optical system of the headlight shown in FIG. 1 in up-down direction (vertical direction) as viewed from the lateral side of the LED 1, and illustrated at FIG. 6(b) is a condition of illumination light irradiated ahead of the vehicle. Illustrated at FIG. 7(a) is a condition of the optical system of the headlight shown in FIG. 1 in left-right direction (horizontal direction) as viewed from above the LED 1, and illustrated at FIG. 7 (b) is a condition of illumination light irradiated ahead of the vehicle. FL1 represents a front focal point of the convex lens 2. By using the LED 1 provided with the mirror reflector 3, at the rear focal point FL2 of the convex lens 2, there is formed a light-emitting face equivalent to that which emits the combined light resulting from combining the direct light of the LED 1 and the reflection light reflected on the mirror reflector 3, so that the combined light passes through the convex lens 2 to be radiated ahead of the vehicle. In the combined light, a portion corresponding to the edge side 1a of the LED 1, that is, near the optical axis of the headlight is brightest to be a maximum emission-intensity portion. Thus, parallel light of the maximum emission-intensity portion having passed through the convex lens 2 brightly illuminates near the cut-off line, so that the cut-off line becomes clear.

Note that in an actual vehicle, as shown in FIG. 5, the cut-off line is present at a place distant more than 5000 mm from the convex lens 2 (ahead of the vehicle), and thus, care should be taken that FIG. 6(a) and FIG. 6(b) are different in scale. Namely, speaking accurately, in FIG. 6(a), a part of the light emitted from the edge side 1a of the LED 1 forms parallel light to illuminate the upper side of the optical axis, so that the cut-off line is not formed into a line matched to the optical axis, and blurred light is present on the cut-off line of the FIG. 6(b). In other words, an up-down direction width of the parallel light corresponds to a width comparable to a diameter of the convex lens 2 (in this case, 50 mm), so that blurred light corresponding to at least the radius of the convex lens 2 is present with the cut-off line. However, a blur of about 25 mm on the cut-off line at the place distant more than 5000 mm from the vehicle is not problematic as a real light-dark boundary, and rather a blur due to another optical factor is much more problematic.

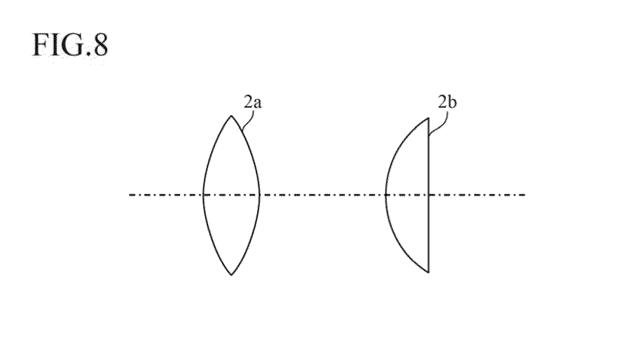

Note that the shape of the convex lens 2 may be other than the shape shown in FIG. 5 to FIG. 7, and thus the lens can also be that in which both faces are convex or only one face is convex, such as a convex lens 2a or 2b shown in FIG. 8.

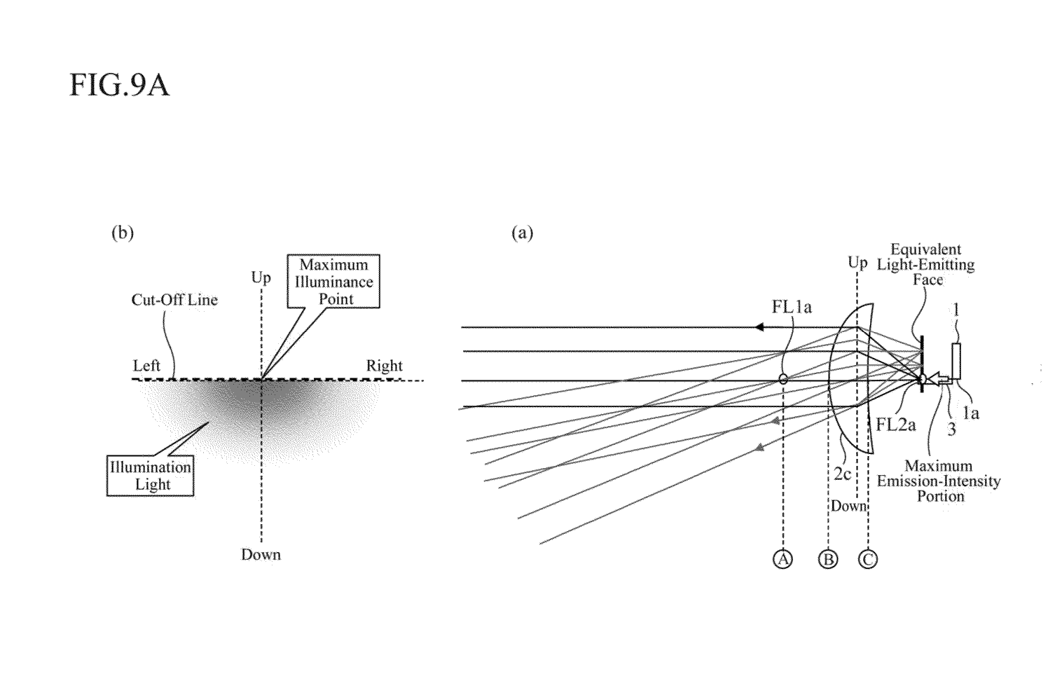

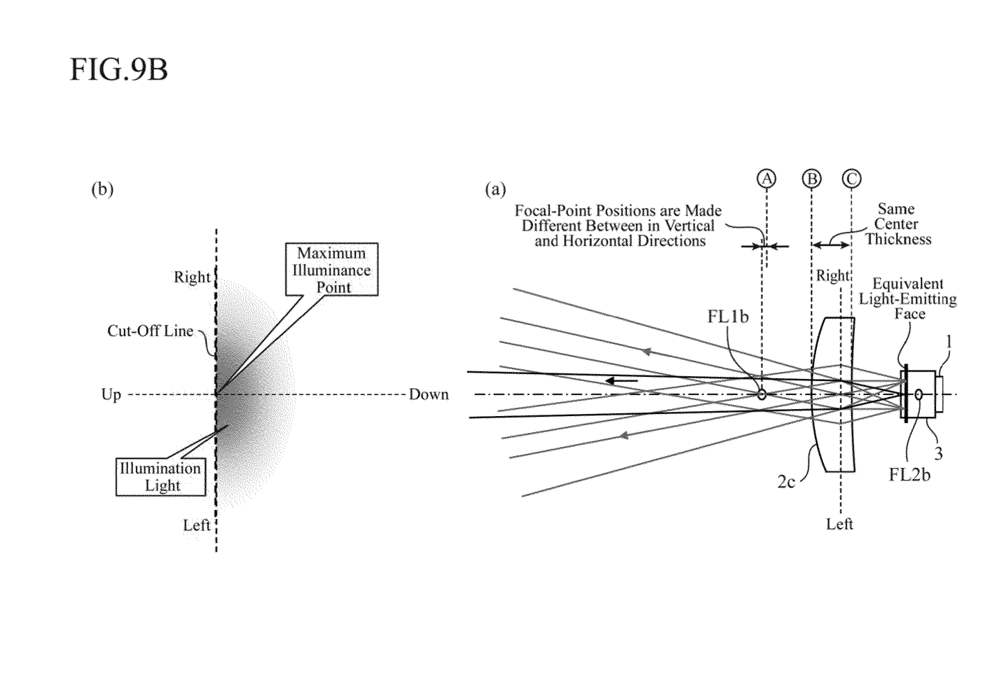

Further, instead of the convex lens 2, for example, an aspherical convex lens 2c having curvatures that are different between in a cross-section in up-down direction and in a cross-section in left-right direction (focal lengths being different) may be used. Illustrated at FIG. 9A(a) is a condition of an optical system using the convex lens 2c in up-down direction (vertical direction) as viewed from the lateral side of the LED 1, and illustrated at FIG. 9A(b) is illumination light in that condition. Illustrated at FIG. 9B(a) is a condition of the optical system using the convex lens 2c in left-right direction (horizontal direction) as viewed from above the LED 1, and illustrated at FIG. 9B(b) is illumination light in that condition. As shown in the figures, in the convex lens 2c, the center thickness is unchanged but the curvatures in a cross-section in up-down direction and in a cross-section in left-right direction are made different to each other so that positions of the rear focal points FL2a, FL2b are made different between in up-down direction and in left-right direction, to thereby shift rearward the position of the rear focal point FL2b in left-right direction relative to the position of the rear focal point FL2a in up-down direction. This makes it possible, while keeping light distribution in up-down direction of the light projected ahead similarly to the above case, to enlarge light distribution in left-right direction.

Consequently, according to Embodiment 1, the light source for headlight is configured to include: the LED 1 provided with the light-emitting face whose edge side 1a is formed into a linear shape and is placed on the optical axis or near the optical axis; and the mirror reflector 3 having the reflection face 3a that is placed in a plane formed by a line parallel to the linear edge side 1a of the LED 1 and a line parallel to the optical axis, said reflection face 3a being in proximity at its one end portion to the linear edge side 1a of the LED 1. Thus, the reflection light reflected on the reflection face 3a is combined with the direct light emitted by the LED 1, so that an intensity of light emitted in a direction normal to the light-emitting face from the edge side 1a can be enhanced equivalently. Accordingly, when the LED 1 is placed upward from the optical axis to thereby form the light distribution for passing light, it is possible to achieve a light source for headlight that brightly illuminates near the cut-off line of passing light so that the cut-off line is formed to be clear.

Note that in the above description, although attention is paid to make clear the cut-off line given as a light-dark boundary, it is possible to form a more preferable light distribution by incorporating an additional optical technique into the above configuration. For that purpose, with respect to a positional relationship between the reflection face 3a and the linear edge side 1a of the LED 1, they are not limited to a strict sense of line that passes along the edge side 1a of the light-emitting face formed into a linear shape, and to a strict sense of the optical axis. In other words, it suffices that the reflection face is placed between the optical axis and the light-emitting face and is in a plane formed by a line parallel to the optical axis and a line parallel to the linear edge side of the light-emitting face.

### Embodiment 2

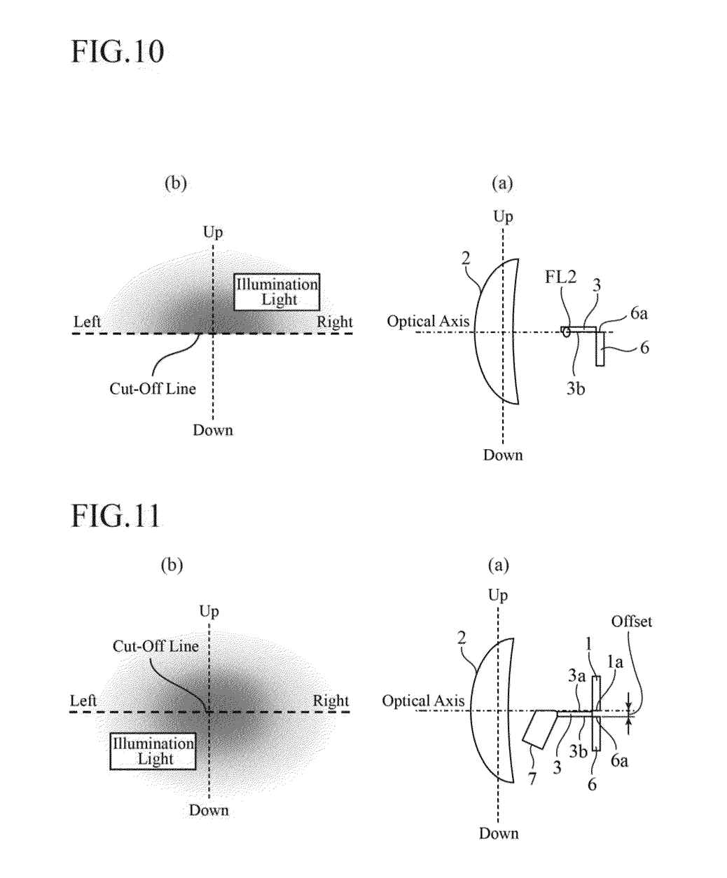

FIG. 10 is a diagram illustrating an optical system of a headlight according to Embodiment 2, in which illustrated at FIG. 10(a) is a condition in up-down direction (vertical direction) as viewed from the lateral side of an upper-illumination LED 6, and illustrated at FIG. 10(b) is a condition of illumination light radiated ahead of a vehicle as viewed from the vehicle-side. Note that, in FIG. 10, the same reference numerals are given for the same or equivalent parts in FIG. 1 to FIG. 9B, so that their description is omitted here.

In Embodiment 1, the headlight for passing light is configured that illuminates the lower side of the optical axis of the headlight, whereas in Embodiment 2, a headlight for upper side illumination is configured that illuminates the upper side of the optical axis of the headlight.

In Embodiment 2, the light-emitting face of the upper-illumination LED (optical source) 6 is placed downward from the optical axis, and an edge side 6a of the light-emitting face in the optical axis-side is formed into a linear shape and placed on the optical axis. Further, a reflection face 3b of the mirror reflector 3 is placed in a plane formed by the edge side 6a of the light-emitting face and the optical axis.

Because of placing the reflection face 3b with the edge side 6a of the upper-illumination LED 6, the reflection light reflected on the reflection face 3b is combined with the direct light emitted by the upper-illumination LED 6 as shown in FIG. 10(a). Thus, it is possible to enhance the light emitted in the normal direction from the edge side 6a of the upper-illumination LED 6. Accordingly, when a projector-type headlight is configured by the upper-illumination LED 6 provided with the mirror reflector 3, as shown in FIG. 10(b), the combined light having passed through the convex lens 2 is projected to the upper side of the optical axis to thereby brightly illuminate near the cut-off line. Thus, light illumination toward the center is enhanced, so that long-distance visibility becomes higher.

Consequently, according to Embodiment 2, the light source for headlight is configured to include: the upper-illumination LED 6 provided with the light-emitting face whose edge side 6a is formed into a linear shape and is placed on the optical axis or near the optical axis; and the mirror reflector 3 having the reflection face 3b that is placed in a plane formed by a line parallel to the linear edge side 6a of the upper-illumination LED 6 and a line parallel to the optical axis, said reflection face 3b being in proximity at its one end portion to the linear edge side 6a of the upper-illumination LED 6. Thus, the reflection light reflected on the reflection face 3b is combined with the direct light emitted by the upper-illumination LED 6, so that an intensity of light emitted in a direction normal to the light-emitting face from the edge side 6a can be enhanced equivalently. Accordingly, it is possible to achieve a light source that illuminates with light the upper portion of the cut-off line for passing light, so that a light distribution for driving light can be formed by a combination of this light source with the passing light.

### Embodiment 3

FIG. 11 is a diagram illustrating an optical system of a headlight according to Embodiment 3 of the invention, in which illustrated at FIG. 11(a) is a condition in up-down direction (vertical direction) as viewed from the lateral side of the passing-purpose LED 1 and the upper-illumination LED 6, and illustrated at FIG. 11(b) is a condition of illumination light radiated ahead of a vehicle as viewed from the vehicle-side. Note that, in FIG. 11, the same reference numerals are given for the same or equivalent parts in FIG. 1 to FIG. 10, so that their description is omitted here.

In Embodiment 3, a headlight for driving light is configured that illuminates the upper and lower sides of the optical axis at the same time. The light distribution for driving light is configured by combining the passing light distribution that is described in Embodiment 1 and that illuminates the lower side of the optical axis of the headlight, and the upper-illumination light distribution that is described in Embodiment 2 and that illuminates the upper side of the optical axis of the headlight.

The light-emitting face of the passing-purpose LED (optical source) 1 is placed upward from the optical axis, and the edge side 1a of the light-emitting face in the optical axis-side is formed into a linear shape and placed on the optical axis. Further, the reflection face 3a of the mirror reflector 3 is placed in a plane formed by a line parallel to the edge side 1a of the light-emitting face and a line parallel to the optical axis.

On the other hand, the light-emitting face of the upper-illumination LED (optical source) 6 is placed downward from the optical axis, and the edge side 6a of the light-emitting face in the optical axis-side is formed into a linear shape and placed apart from the optical axis by providing a gap (indicated as offset in FIG. 11(a)) due to thickness of the mirror reflector 3 and restriction in mounting the LED. Further, the reflection face 3b of the mirror reflector 3 is placed in a plane formed by a line parallel to the edge side 6a of the light-emitting face and a line parallel to the optical axis.

By lighting up the passing-purpose LED 1 in the upper side of the optical axis, the emitted light is projected through the convex lens 2 to the lower side of the optical axis, so that a light distribution for passing light is formed. Meanwhile, by lighting up, at the same time, the passing-purpose LED 1 in the upper side of the optical axis and the upper-illumination LED 6 in the lower side of the optical axis, the emitted light are projected through the convex lens 2 to the upper and lower sides of the optical axis, so that a light distribution for driving light shown in FIG. 11(b) is formed.

On this occasion, corresponding to the gap interposed between the passing-purpose LED 1 and the upper-illumination LED 6 (for example, a gap due to thickness of the mirror reflector 3 and restriction in mounting the LED), a space (non-emitting portion) is developed between the passing-purpose LED 1 and the upper-illumination LED 6. Thus, a dark portion corresponding to the space emerges above the cut-off line during lighting driving light (lighting up the passing-purpose LED 1 and the upper-illumination LED 6).

Thus, in Embodiment 3, a light guide member 7 is placed between the convex lens 2 for projection and the mirror reflector 3, to thereby change a direction of light. In FIG. 11(a), as the light guide member 7, a plate-like transparent prism or a light guide plate is used.

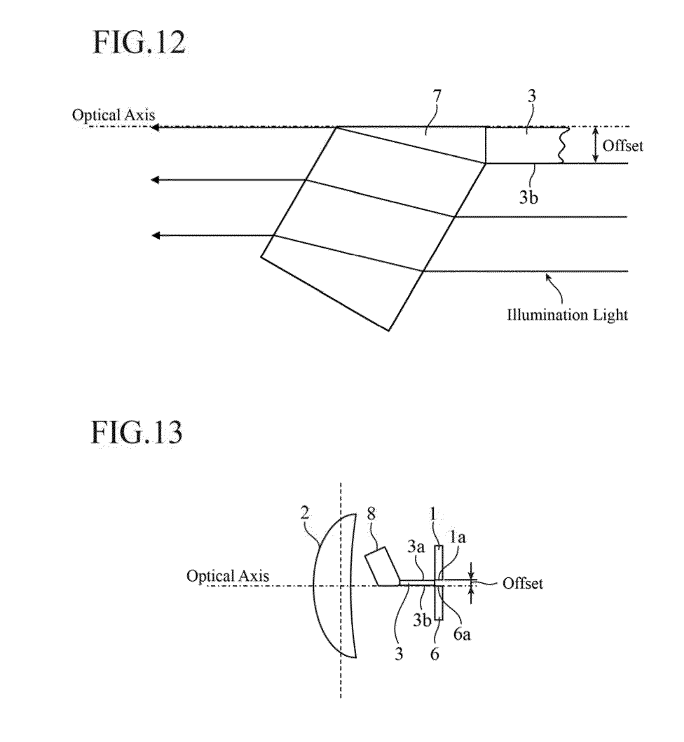

Shown in FIG. 12 is an enlarged view of the mirror reflector 3 and the light guide member 7 in FIG. 11(a). As shown in FIG. 11(a) and FIG. 12, between the convex lens 2 and the mirror reflector 3, the light guide member 7 that is transparent and plate-like is placed to be in a state inclined relative to a plane perpendicular to the optical axis, so that the light emitted by the upper-illumination LED 6 can be bent toward the optical axis by the light guide member 7. By bending the light emitted by the upper-illumination LED 6, the thickness of the mirror reflector 3 (indicated as offset) can be optically compensated, so that the edge side 6a of the upper-illumination LED 6 at a portion apart from the optical axis can be placed equivalently as if on the optical axis. Note that in the light guide member 7, an incident face on which the light emitted from the upper-illumination LED 6 is incident and an outgoing face through which the incident light goes out, are formed in parallel.

As shown in FIG. 11(a) and FIG. 12, when the light guide member 7 is provided in the lower side of the optical axis so that the cut-off line is formed by the reflection face 3b of the mirror reflector 3, the deviation in focal point (aberration) of the convex lens 2 according to light wavelengths (emitted-light colors) is reduced, and thus, dispersion into rainbow colors of the illumination light emitted by the passing-purpose LED 1 and illuminating near the cut-off line, is mitigated.

The other light emitted by the upper-illumination LED 6 is mixed with the light by the passing-purpose LED 1 that is lit up simultaneously to be used for driving light, and thus, even if it is dispersed by the prism effect of the light guide member 7, the dispersed light is unlikely to be visible.

In such a manner, when the face on which the light is incident and the face through which the light goes out are formed in parallel, namely, when the transparent light guide member 7 that is formed into a plate-like is used, it is possible to bend the incident light in a crank fashion to bring it closer toward the optical axis and to cause it to go out in the same direction of the incident light. Thus, it is possible to offset the light emitted by the upper-illumination LED 6.

Consequently, according to Embodiment 3, the light source for headlight is configured to include: the passing-purpose LED 1 provided with the light-emitting face whose edge side 1a is formed into a linear shape and placed on the optical axis; the upper-illumination LED 6 provided with the light-emitting face whose edge side 6a is formed into a linear shape and placed apart from the optical axis by providing a gap due to thickness of the mirror reflector 3, restriction in mounting the LED and the like; the mirror reflector 3 having the reflection face 3a that is placed in a plane formed by a line parallel to the edge side 1a and a line parallel to the optical axis, and the reflection face 3b that is placed in a plane formed by a line parallel to the edge side 6a and a line parallel to the optical axis, said reflection face 3a being in proximity to the edge side 1a and said reflection face 3b being in proximity to the edge side 6a; and the light guide member 7 placed between the mirror reflector 3 and the convex lens 2, that brings the light emitted from the light-emitting face 3b closer toward the optical axis. Thus, alight source for head light that forms alight distribution for passing light and a light distribution for driving light can be achieved by a single set of optical sources. Further, because the linear edge side 6a of the upper-illumination LED 6 that is placed apart from the optical axis, is placed equivalently as if on the optical axis by use of the light guide member 7, it is possible to optically compensate the gap between the light-emitting faces of the passing-purpose LED 1 and the upper-illumination LED 6 that is due to thickness of the mirror reflector 3 etc., to thereby achieve a light source for headlight that does not cause a dark portion in the upper side of the cut-off line during lighting driving light.

Further, according to Embodiment 3, the light guide member 7 is configured so that its outgoing face through which the light emitted from the light-emitting face of the upper-illumination LED 6 goes out, is inclined relative to a plane perpendicular to the optical axis of the headlight, and is further configured so that the outgoing face and the incident face on which the light emitted from the light-emitting face of the upper-illumination LED 6 is incident, are made parallel to each other. Thus, it is possible to cause light to go out in the same direction of the incident light while bending the incident light.

Note that in the configuration example of FIG. 11 and FIG. 12, since the edge side 1a of the passing-purpose LED 1 is placed to be aligned with the optical axis, the light guide member 7 is placed in the lower side of the optical axis in order to avoid influence by the upper-illumination LED 6 being apart from the optical axis because of thickness of the mirror reflector 3, restriction in mounting the LED and the like (because of the offset); however, it is allowable to inversely place the edge side 6a of the upper-illumination LED 6 to be aligned with the optical axis and the passing-purpose LED 1 to be apart from the mirror reflector 3. An optical system of the thus-configured headlight is shown in FIG. 13, and an enlarged view of the mirror reflector 3 and a light guide member 8 therein is shown in FIG. 14.

As shown in FIG. 3 and FIG. 14, according to the configuration in which the light guide member 8 is placed in the upper side of the optical axis, the light guide member 8 can be placed toward the convex lens 2 from the front end of the mirror reflector 3 in the LED 6-side. That is, like Embodiment 9 to be mentioned later, even when partitioning mirror reflectors 11-1 to 11-4 are provided between LEDs, their front ends can be at the same position of that of the mirror reflector 3 (opening portions by the front ends of the mirror reflector 3 and the partitioning mirror reflectors 11-1 to 11-4 can be given as equivalent light-emitting faces of the LEDs). Thus, it is possible to achieve a configuration similar to the case described in the later-mentioned Embodiment 9 where the opening portions of the partitioning mirror reflectors 11-1 to 11-4 are shifted rearward relative to the front end of the mirror reflector 3 in the convex lens 2-side.

In detail, one end portion of the light guide member 8 at which the cut-off line for passing light is formed, is placed near the rear focal point FL2 of the convex lens 2, and the other end portion of the light guide member 8 is placed toward the equivalent light-emitting faces of the upper-illumination LED 6. Accordingly, the equivalent light-emitting faces of the upper-illumination LED 6 are placed behind the rear focal point FL2 of the convex lens 2 according to the thickness of the light guide member 8, so that outlines of the equivalent light-emitting faces of the upper-illumination LED 6 can be projected clearly ahead of the vehicle.

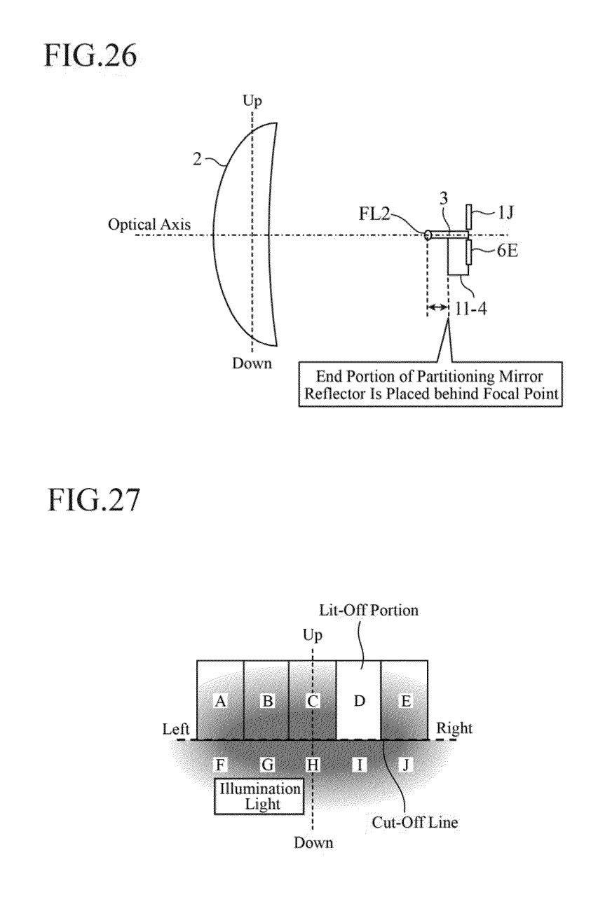

As described above, this configuration is comparable to the case described in the later-mentioned Embodiment 9 with reference to FIG. 26 where the front ends of the partitioning mirror reflectors 11-1 to 11-4 (see, FIG. 25) are placed behind an end portion of the mirror reflector 3 that is placed at the rear focal point FL2. Thus, this configuration is favorable in a method to be described in the following Embodiment 9 in which the upper-illumination LED 6 is used for making individual lighting-up/lighting-off.

Note that, because a blur and loss occurs in the light passing through the light guide member 7 or 8, the headlight of FIG. 11 and FIG. 12 in which the edge side 1a of the passing-purpose LED 1 is placed on the optical axis and the light guide member 8 is not provided in the passing light side, is advantageous over the headlight of FIG. 13 to FIG. 15 in which the edge side 1a of the passing-purpose LED 1 is placed apart from the optical axis and the light guide member 8 is provided, in view of reducing a loss of passing light that is used frequently and in view of forming a clear cut-off line for passing light, so that it is favorable in the case of forming light distributions for passing light and driving light by a single set of optical sources.

A relationship between a thickness t of the light guide member 8 and an offset (OFFSET) corresponding to a gap due to thickness of the mirror reflector 3, restriction in mounting the LED and the like, is given by the following formula (1).

$$t = \frac{OFFSET \times cos ( r )}{sin ( θ - r )} \qquad ( 1 )$$

Here, a relationship between an incident angle (i) of the light that is incident, as shown in FIG. 14, to the light guide member 8 in a direction parallel to the optical axis, and an inclination (θ) of the light guide member 8 relative to the optical axis is (i)=(θ). By calculating a refraction angle (r) from the relative refractive index (n) of the light guide member 8=sin(i)/sin(r), followed by substituting the angle into the above formula (1), the thickness t of the light guide member 8 can be obtained.

With respect also to the plate thickness of the light guide member 7 in the lower side of the optical axis, although its illustration is omitted, it suffices to similarly set the thickness.

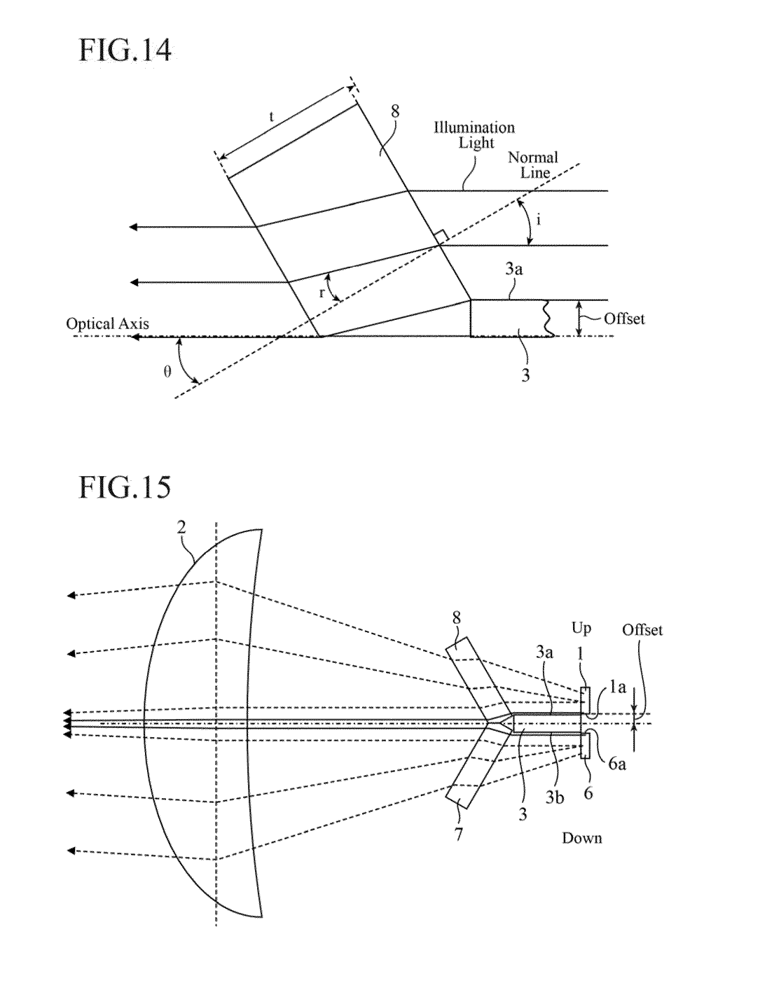

Further, as shown in FIG. 15, it is allowable that the edge side 1a of the passing-purpose LED 1 and the edge side 6a of the upper-illumination LED 6 are placed apart respectively from the optical axis, and the light guide member 8 and the light guide member 7 are placed in the upper side and in the lower side of the optical axis, respectively. When the light guide members 7, 8 are provided in the upper and lower sides, optical positions of the passing-purpose LED 1 and the upper-illumination LED 6 become comparable to each other, and thus, conditions in the upper and lower sides of the cut-off line of illumination light projected through the convex lens 2 becomes comparable, so that driving light can be formed without uncomfortable feeling about the cut-off line. Thus, this is favorable to simply form passing light and driving light.

Further, in the case of FIG. 15, the plate thicknesses of the respective upper and lower light guide members 7, 8 are allowed to be thin so that light dispersion occurring by the prism effect of the light guide members 7, 8 is mitigated.

### Embodiment 4

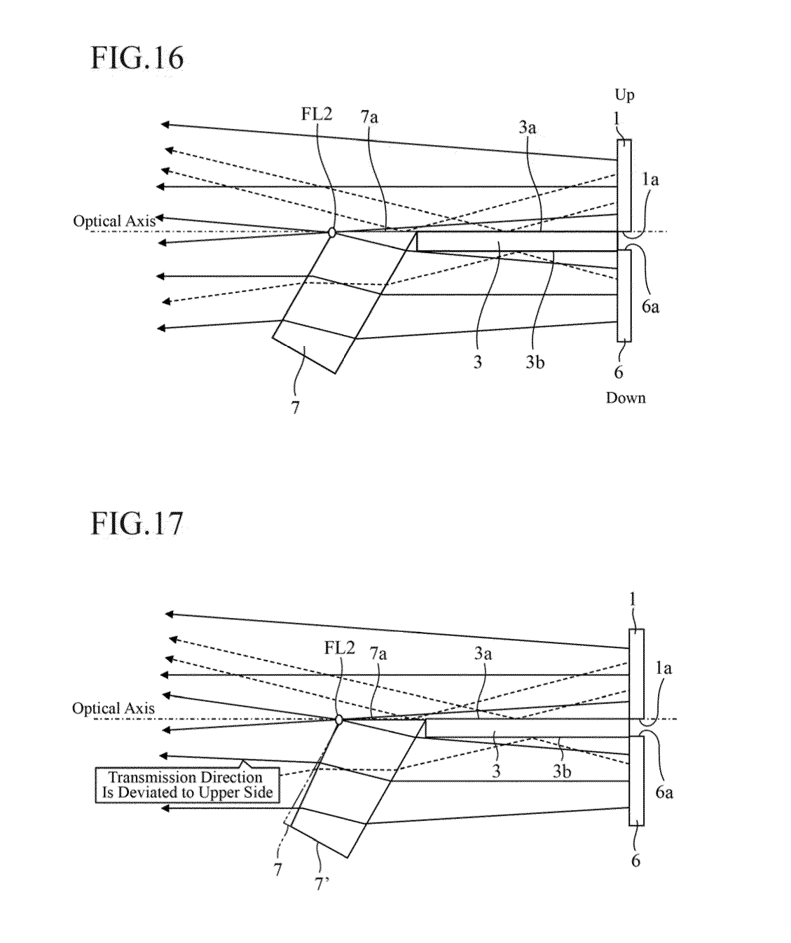

FIG. 16 is a diagram illustrating an optical system of a headlight according to Embodiment 4, in which illustrated is a condition in up-down direction (vertical direction) as viewed from the lateral side of the passing-purpose LED 1 and the upper-illumination LED 6. Note that, in FIG. 16, the same reference numerals are given for the same or equivalent parts in FIG. 1 to FIG. 15, so that their description is omitted here. Here is exemplified an optical system of a projection-type headlight for driving light in which the edge side 1a of the passing-purpose LED 1 and the reflection face 3a of the mirror reflector 3 are placed on the optical axis, and the edge side 6a of the upper-illumination LED 6 and the reflection face 3b is placed apart from the optical axis.

Even though the light guide member 7 is transparent, the light incident on the surface of the light guide member 7 at a shallow angle is totally reflected, and thus, the face of the light guide member 7 can be used as a reflection face depending on the incident angle of light. Accordingly, when an upper face 7a of the light guide member 7 provided between the mirror reflector 3 and the convex lens 2 (not shown) is placed on the optical axis to be coplanar with the reflection face 3a of the mirror reflector 3 as shown in FIG. 16, it is possible to cause the upper face 7a to function as a reflection face. By making coplanar the reflection face 3a of the mirror reflector 3 and the upper face 7a of the light guide member 7 with each other, positional precision of the mirror reflector 3 and the light guide member 7 can be enhanced.

Meanwhile, because the upper face 7a that is coplanar with the reflection face 3a serves as a boundary between upper and lower light distributions of the cut-off line, an end portion of the upper face 7a is placed near the rear focal point FL2 of the convex lens 2.

Note that in FIG. 16, illustration has been made about a configuration that utilizes, as a reflection face, the upper face 7a of the light guide member 7 placed in the lower side of the optical axis; however, in the case of placing the light guide member 8 in the upper side of the optical axis, it is also allowable to utilize the lower face of the light guide member 8 as a reflection face.

Further, in FIG. 16, although the light guide member 7 is exemplified to have a shape in which the incident face and the outgoing face are parallel to each other, it is also allowable to use a light guide member 7′ having a shape in which the incident face is inclined relative to the outgoing face.

An optical system of the headlight using the light guide member 7′ is shown in FIG. 17. In the example of FIG. 17, the light guide member 7′ is used that is transparent and formed into a shape in which the face on which light is incident is inclined relative to the face through which light goes out, in other words, formed into a triangle prism shape or a lens shape. This causes light to go out in a direction different to the direction of the incident light while deflecting the incident light.

For example, as shown in FIG. 17, when the light guide member 7′ is placed between the mirror reflector 3 and the unshown convex lens 2 and in the lower side of the optical axis while the light guide member 7′ is formed thick at its upper portion and thin at its lower portion, the light passing therein is deflected toward the optical axis. This causes a part of the light emitted from the upper-illumination LED 6 to be deflected toward the optical axis, thus making it possible, during lighting driving light, to illuminate near the cut-off line more brightly due to reinforcement by the deflected light.

Consequently, according to Embodiment 4, it is configured so that one face of the light guide member 7 is placed coplanar with the reflection face 3a of the mirror reflector 3, so as to function as a reflection face. Thus, the mirror reflector 3 and the light guide member 7 can be formed as a single member, so that when mounted in the casing 4, the positional precision of the mirror reflector 3 and the light guide member 7 relative to the rear focal point FL2 of the convex lens 2 can be enhanced. Further, when a light distribution for driving light is formed using the light source for headlight, no dark portion emerges in the upper side of the cut-off line.

Further, according to Embodiment 4, since the light guide member 7′ is configured so that the outgoing face through which the light emitted from the light-emitting face of the upper-illumination LED 6 is inclined relative to a plane perpendicular to the optical axis of the headlight, it is possible to cause the incident light to go out while bending it to be closer toward the optical axis. Further, with respect to the light guide member 7′, the outgoing face is inclined relative to the incident face, so that the light incident to the light guide member 7′ from the upper-illumination LED 6 can be brought to an illumination region to be dealt with by the passing-purpose LED 1, thus making it possible to increase brightness of the portion illuminated by the passing-purpose LED 1. In addition, such a light source can be achieved that illuminates near the cut-off line more brightly during lighting driving light.

Note that, although the illustration is omitted, similarly to the light guide member 7, it is also allowable that the incident face of the light guide member 8 is inclined relative to the outgoing face to thereby bring the light emitted by the passing-purpose LED to an illumination region to be dealt with by the upper-illumination LED 6.

Further, in the above description, although attention is paid to make clear the cut-off line given as a light-dark boundary, it is possible to form a more preferable light distribution by incorporating an additional optical technique into the above configuration. For that purpose, the position of an upper-face end portion of the light guide member to be placed near the rear focal point FL2 of the convex lens 2 is not limited to a strict sense of rear focal point FL2 of the convex lens 2. Likewise, with respect to a positional relationship between the reflection face and the linear edge side of the LED, they are not limited to a strict sense of line that passes along the edge side of the light-emitting face formed into a linear shape, and to a strict sense of line parallel to the optical axis. In other words, it suffices that the reflection face is placed between the optical axis and the light-emitting face and is in a plane formed by a line parallel to the optical axis and a line parallel to the linear edge side of the light-emitting face.

### Embodiment 5

In Embodiment 4, there is provided a configuration in which the reflection face 3a of the mirror reflector 3 and the upper face 7a of the light guide member 7 are caused to function as a reflection face; however, it is allowable to omit the mirror reflector 3 by causing the upper face 7a of the light guide member 7 to function instead as the reflection face 3a of the mirror reflector 3.

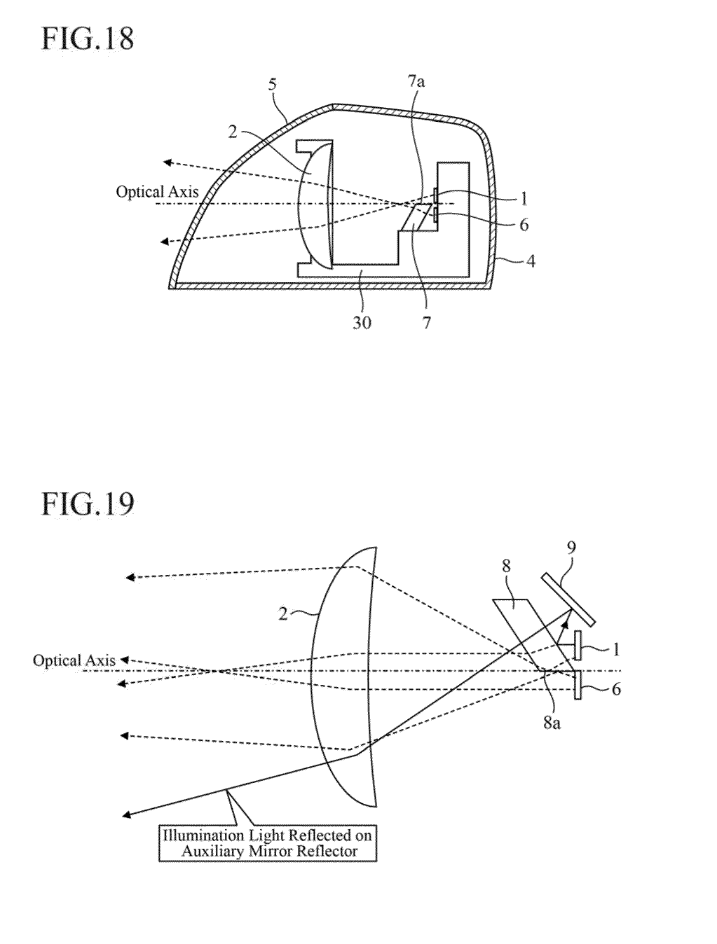

FIG. 18 shows a cross-sectional view a headlight according to Embodiment 5, in which the same reference numerals are given for the same or equivalent parts in FIG. 1 to FIG. 17, so that their description is omitted here. In FIG. 18, a support member 30 that serves also as a heat sink of the passing-purpose LED 1 and the upper-illumination LED 6, supports the convex lens 2 and the light guide member 7. Further, the edge side 1a of the passing-purpose LED 1 is placed on the optical axis of the headlight and its light emitting face is placed in the upper side of the optical axis. The upper face 7a of the light guide member 7 is placed on the optical axis so that the light emitted by the passing-purpose LED 1 is reflected thereon, to thereby illuminate near the cut-off line brightly.

Even in this configuration, similarly to Embodiment 4, because the upper face 7a of the light guide member 7 serves as a boundary between upper and lower light distributions of the cut-off line, an end portion of the upper face 7a is placed near the rear focal point FL2 (not shown) of the convex lens 2.

Further, the light emitted from the upper-illumination LED 6 that is placed apart from the optical axis of the headlight, is bent toward the optical axis while transmitting through the light guide member 7, so that the length from the optical axis to the edge side 6a can be optically compensated. Further, the upper face 7a of the light guide member 7 also function as a mirror reflector that internally reflects the light incident from the upper-illumination LED 6 to the light guide member 7, so that the light emitted by the upper-illumination LED 6 is reflected thereon, to thereby illuminate near the cut-off line brightly.

Consequently, according to Embodiment 5, the light source for headlight includes: the light guide member 7 having on the optical axis, the upper face 7a that functions as a mirror reflector; the passing-purpose LED 1 provided with the light-emitting face whose edge side 1a is formed into a linear shape and is placed on or near the optical axis; and the upper-illumination LED 6 existing at a position apart from the optical axis; wherein the upper face 7a of the light guide member 7 and the linear edge side 1a of the passing-purpose LED 1 are placed in proximity to each other, said upper face being provided as a reflection face that is placed in a plane formed by a line parallel to the linear edge side 1a of the passing-purpose LED 1 and a line parallel to the optical axis. Thus, the reflection light reflected on the upper face 7a of the light guide member 7 that functions as a reflection face, is combined with the direct light emitted by the passing-purpose LED 1, so that an intensity of light emitted in a direction normal to the light-emitting face from the edge side 1a can be enhanced equivalently. Accordingly, a portion near the cut-off line of passing light is brightly illuminated with the light emitted by the passing-purpose LED 1, to form a clear cut-off line.

Further, using the light guide member 7, the linear edge side 6a of the upper-illumination LED 6 that is placed apart from the optical axis, is placed equivalently as if on the optical axis. Thus, it is possible to optically compensate the gap between the passing-purpose LED 1 and the upper-illumination LED 6 that is due to restriction in mounting the LED and the like, so that no dark portion emerges in the upper side of the cut-off line during lighting driving light.

Furthermore, the reflection light reflected on the upper face 7a of the light guide member 7 that functions as a reflection face, is combined with the direct light emitted by the upper-illumination LED 6, so that an intensity of light emitted in a direction normal to the light-emitting face from the edge side 6a can be enhanced equivalently. Thus, a portion near the cut-off line is illuminated brightly with the light emitted by the upper-illumination LED 6.

From the above, a light source for head light that forms a light distribution for passing light and a light distribution for driving light can be achieved by a single set of optical sources.

Note that, in the above description, although attention is paid to make clear the cut-off line given as a light-dark boundary, it is possible to form a more preferable light distribution by incorporating an additional optical technique into the above configuration. For that purpose, the position of the upper face 7a of the light guide member 7 is not limited to a strict sense of optical axis, so that the upper face may be placed between the optical axis and the light-emitting face. Further, the position of the upper-face end portion of the light guide member 7 is not limited to a strict sense of rear focal point FL2 of the convex lens 2, and may be configured to be placed near that point.

### Embodiment 6

FIG. 19 is a diagram illustrating an optical system of a headlight according to Embodiment 6, in which illustrated is a condition in up-down direction (vertical direction) as viewed from the lateral side of the passing-purpose LED 1 and the upper-illumination LED 6. Note that, in FIG. 19, the same reference numerals are given for the same or equivalent parts in FIG. 1 to FIG. 18, so that their description is omitted here.

In FIG. 19, the edge side 6a of the upper-illumination LED 6 and a lower face 8a of the light guide member 8 are placed on the optical axis, to thereby enhance light emitted from the edge side 6a in the normal direction by utilizing the lower face 8a as a reflection face. Further, the passing-purpose LED 1 is placed above the optical axis to be apart from the optical axis, to thereby cause the light emitted by the passing-purpose LED 1 to be bent by the light guide member 8 to become closer toward the optical axis. In addition, the lower face 8a of the light guide member 8 functions not only as a reflection face that reflects the light emitted by the upper-illumination LED 6, but also as a mirror reflector that internally reflects the light incident into the light guide member 8 from the passing-purpose LED 1.

On this occasion, a part of the light emitted by the passing-purpose LED 1 is reflected on the face of the light guide member 8 on which the light is to be incident. This reflected light is reflected by an auxiliary mirror reflector 9 (a second reflection face) provided behind the light guide member 8, so as to be brought to the light guide member 8 again. This makes it possible to effectively utilize the light emitted by the passing-purpose LED 1.

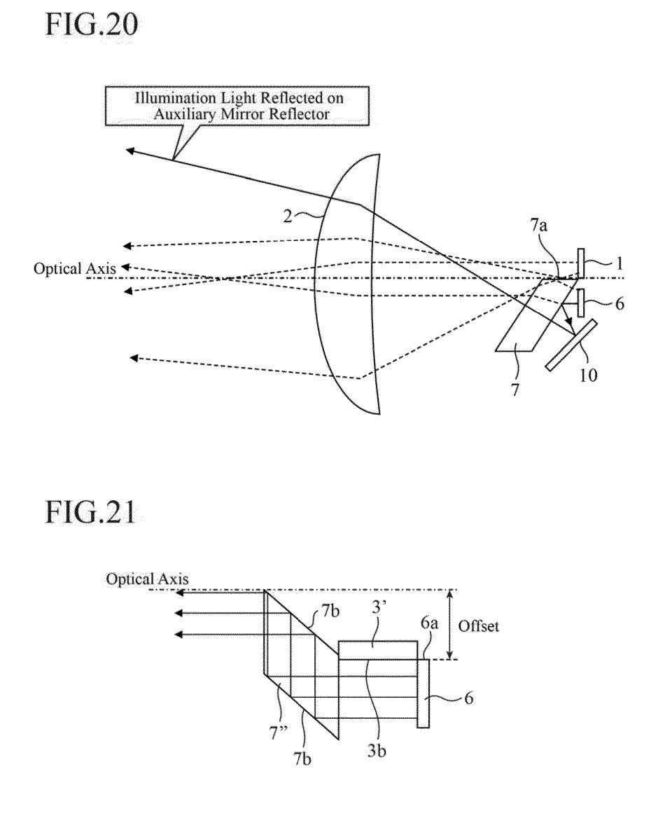

FIG. 20 is a diagram illustrating a modified example of the optical system of the headlight according to Embodiment 6, in which illustrated is a condition in up-down direction (vertical direction) as viewed from the lateral side of the passing-purpose LED 1 and the upper-illumination LED 6. In FIG. 20, the edge side 1a of the passing-purpose LED 1 and the upper face 7a of the light guide member 7 are placed on the optical axis, to thereby enhance light emitted from the edge side 1a in the normal direction by utilizing the upper face 7a as a reflection face. Further, the upper-illumination LED 6 is placed below the optical axis to be apart from the optical axis, to thereby cause the light emitted by the upper-illumination LED 6 to be bent by the light guide member 7 to become closer toward the optical axis. In addition, the upper face 7a of the light guide member 7 functions not only as a reflection face that reflects the light emitted by the passing-purpose LED 1, but also as a mirror reflector that internally reflects the light incident into the light guide member 7 from the upper-illumination LED 6.

On this occasion, similarly to the case of FIG. 19, a part of the light emitted by the upper-illumination LED 6 is reflected on the face of the light guide member 7 on which the light is to be incident. This reflected light is reflected by an auxiliary mirror reflector 10 (a second reflection face) provided behind the light guide member 7, so as to be brought to the light guide member 7 again. This makes it possible to effectively utilize the light emitted by the upper-illumination LED 6.

Consequently, according to Embodiment 6, the light source for head light is configured to include, in the sides of the light guide members 7, 8 toward the optical sources, respectively, the auxiliary mirror reflectors 9, 10 (second reflection faces) that reflect the light having been reflected on the incident faces of the light guide members 7, 8, toward the incident faces again. Thus, it is possible to efficiently utilize the light emitted from the passing-purpose LED 1 and the upper-illumination LED 6, to thereby achieve a light source for headlight that brightly illuminates ahead with low power.

### Embodiment 7

FIG. 21 is a diagram illustrating an optical system of a headlight according to Embodiment 7, in which illustrated is a condition in up-down direction (vertical direction) as viewed from the lateral side of the upper-illumination LED 6. Note that, in FIG. 21, the same reference numerals are given for the same or equivalent parts in FIG. 1 to FIG. 20, so that their description is omitted here.

Here is exemplified an optical system of the headlight in which the edge side 6a of the upper-illumination LED 6 and the reflection face 3b are placed apart from the optical axis, and the passing-purpose LED 1 and so on placed in the upper side of the optical axis are omitted from illustration. In Embodiment 7, the distance corresponding to the gap is also offset by bending the light emitted by the upper-illumination LED 6 using the light guide member 7; however, as the light guide member 7, a light guide member 7″ (prism) is used that includes reflection faces 7b (second inner-reflection faces) that internally reflect the incident light, in addition to the face on which the light is incident and the face through which the light goes out.

For example, as shown in FIG. 21, the light guide member 7″ is placed between a mirror reflector 3′ and the unshown convex lens 2 and in the lower side of the optical axis, with the incident face and the outgoing face of the light guide member 7″ being placed perpendicular to the optical axis. In the light guide member 7″, there are formed two number of the reflection faces 7b (second inner-reflection faces) that internally reflect the incident light two times each by 90 degrees, so that the light that passed through the light guide member 7″ had been bent toward the optical axis. This makes it possible to optically compensate the length from the optical axis to the edge side 6a (indicated as offset in FIG. 21) by bending the light emitted by the upper-illumination LED 6 toward the optical axis, so that the edge side 6a can be placed equivalently as if on the optical axis.

Note that in the configuration of FIG. 21, because the light guide member 7″ bends the incident light using the reflection faces 7b (second inner-reflection faces), the dispersion of the light is reduced. On the other hand, it is required that the reflection faces 7b each have an area sufficient for the light-emitting face of the upper-illumination LED 6, so that the upper-illumination LED 6 is necessary to be placed apart largely from the optical axis by more than the gap due to thickness of the mirror reflector 3, restriction in mounting the LED, etc.

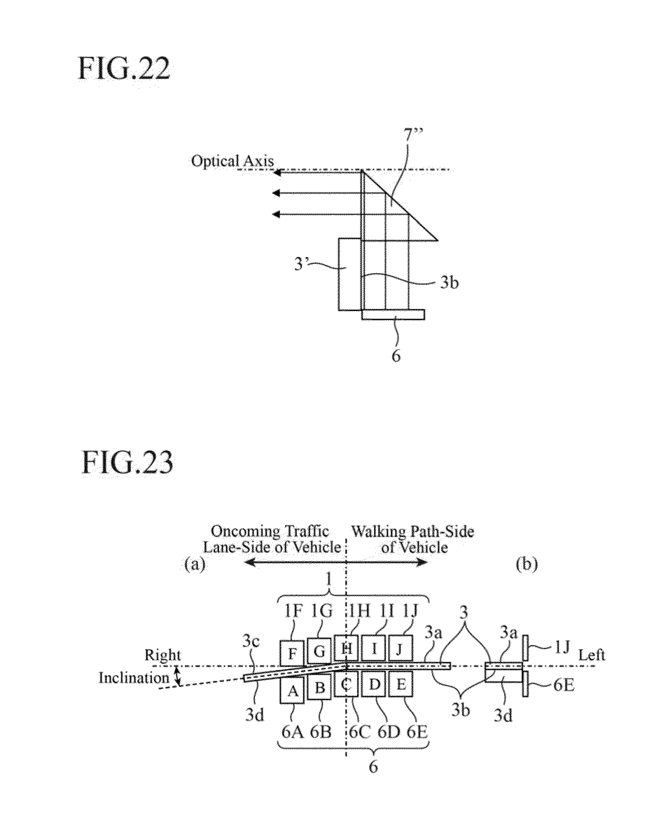

As the configuration with the light guide member 7″ for placing the LED equivalently as if on the optical axis, for example, a configuration as shown in FIG. 22 may be thought as well. In FIG. 22, the light-emitting face of the upper-illumination LED 6 is placed parallel to the optical axis, thus providing a configuration in which light is emitted from the upper-illumination LED 6 toward the optical axis, and the light guide member 7″ is placed between the upper-illumination LED 6 and the optical axis. The light guide member 7″ whose incident face is formed parallel to the optical axis and whose outgoing face is formed perpendicular to the optical axis, reflects the light having entered through the incident face once at the inner reflection face 7b thereby to bend the light by 90 degrees and to cause the light to go out in a direction parallel to the optical axis.

In the configuration of FIG. 22, however, a plane on which the upper-illumination LED 6 is mounted (in horizontal direction) is different to a plane on which the unshown passing-purpose LED 1 is mounted (in vertical direction), so that the headlight becomes complex in structure, thus making it difficult to ensure optical precision in positions. Further, the light-emitting face of the upper-illumination LED 6 is oriented in a direction parallel to the optical axis, and thus, for conforming therewith, the mirror reflector 3′ is required to be placed perpendicular relative to the optical axis.

As just described, the configuration of FIG. 22 is more complex than the configuration of the invention and departs from a configuration “a light-emitting face placed perpendicular to an optical axis of the headlight” of the invention, and thus, it is treated for reference.

Consequently, according to Embodiment 7, the light guide member 7″ is configured to have: the face on which the light emitted from the light-emitting face of the upper-illumination LED 6 is incident; the reflection faces 7b (second inner-reflection faces) on which the light is internally reflected; and the face through which the light goes out. Thus, even when the upper-illumination LED 6 is placed apart largely from the optical axis, the distance corresponding to the gap can be offset by bending the light emitted by the upper-illumination LED 6 using the light guide member 7″. Accordingly, it is possible to achieve a light source for headlight that does not cause a dark portion in the upper side of the cut-off line during lighting driving light.

### Embodiment 8

FIG. 23 is a diagram illustrating an optical system of a projector-type headlight for driving light according to Embodiment 8, in which shown at FIG. 23(a) is a plan view of respective light-emitting faces A to J of the passing-purpose LED 1 and the upper-illumination LED 6, as viewed from the convex lens 2-side, and shown at FIG. 23(b) is its side view. Note that, in FIG. 23, the same reference numerals are given for the same or equivalent parts in FIG. 1 to FIG. 22, so that their description is omitted here.

The passing-purpose LED 1 is configured with a plurality of LEDs 1F to 1J, and the upper-illumination LED 6 is configured with a plurality of LEDs 6A to 6E. Further, in the reflection faces 3a, 3b of the mirror reflector 3, reflection-face regions 3c, 3d that are placed in the oncoming traffic lane-side of the vehicle, are formed along a downwardly-inclined shape. Thus, the reflection-face regions 3c, 3d placed in the oncoming traffic lane-side of the vehicle are arranged at positions lower than the reflection faces 3a, 3b placed in the walking path-side.

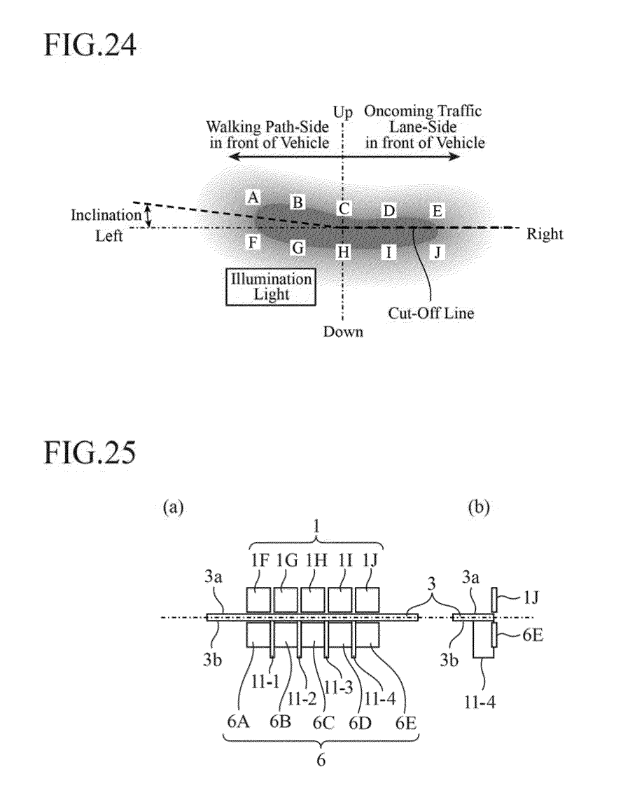

In FIG. 24, there is shown a condition of illumination light radiated ahead of the vehicle in the case where all light-emitting faces A to J of the LEDs 1F to 1J and the LEDs 6A to 6E are lit up. In FIG. 24, illumination regions corresponding to the light-emitting faces A to J in FIG. 23 are indicated as A to J.

The cut-off line is formed by: lower edge sides of the light-emitting faces F to J of the LEDs 1F to 1J placed in the upper side of the optical axis of the headlight; the reflection-face regions 3c, 3d placed in the oncoming traffic lane-side of the vehicle; and the reflection faces 3a, 3b placed in the walking path-side; and a portion in the lower side of the cut-off line is illuminated by the LEDs 1F to 1J to thereby form a light distribution for passing light. Namely, the cut-off line includes a bend corresponding to the bend between the reflection-face regions 3c, 3d placed in the oncoming traffic lane-side of the vehicle and the reflection faces 3a, 3b placed in the walking path-side. Thus, it is possible to achieve the light distribution for passing light that illuminates up to a high position in the walking path-side in front of the vehicle, and illuminates a low position in the oncoming traffic lane-side in front of the vehicle at which the driver driving an oncoming vehicle is never dazzled.

On the other hand, the light emitted from the light-emitting faces A to E of the LEDs 6A to 6E placed in the lower side of the optical axis of the headlight, illuminates the upper side of the bent cut-off line for passing light. Namely, by combining the light emitted by the LEDs 6A to 6E with the light emitted by the LEDs 1F to 1J, a light distribution for driving light is formed.

Note that, although the illustration is omitted in FIG. 23, the light guide member 7 (or the light guide member 8) is placed between the mirror reflector 3 and the unshown convex lens 2, to thereby optically compensate the gap due to thickness of the mirror reflector 3, restriction in mounting the LED, etc.

Consequently, according to Embodiment 8, there is provided a configuration in which the reflection faces 3a, 3b of the mirror reflector 3 are compartmented into the reflection-face regions 3c, 3d placed in the oncoming traffic lane-side of the vehicle and the reflection-face regions 3a, 3b placed in the walking path-side, said reflection-face regions 3c, 3d placed in the oncoming traffic lane-side configured to be formed lower than the reflection-face regions 3a, 3b placed in the walking path-side. Thus, it is possible to achieve a light source for headlight by which the light radiated ahead of the vehicle forms a cut-off line for passing light with a combination of a light distribution horizontally existing in the oncoming traffic lane-side at the lower position at which the driver driving an oncoming vehicle is never dazzled, and a light distribution in the walking path-side that illuminates up to a position higher than in the oncoming traffic lane-side.

Note that in FIG. 23 and FIG. 24, assuming the use for the left-hand side driving, the left side of the vehicle is given as the walking path-side and the right side thereof is given as the oncoming traffic lane-side, so that the right-side portion of the mirror reflector 3 is shaped to be inclined diagonally downward; however, in the use for the right-hand side driving, the right side of the vehicle is given as the walking path-side and the left side thereof is given as the oncoming traffic lane-side, so that it suffice to shape the left-side portion of the mirror reflector 3 to be inclined diagonally downward.

Further, in the case where the reflection face 3a of the mirror reflector 3 and the upper face 7a of the light guide member 7 are to be made coplanar and the upper face 7a is caused to function as a reflection face (the configuration in Embodiment 3), it suffices to form the upper face 7a to be partially inclined while being coplanar with the reflection face 3a of the mirror reflector 3 as well as the reflection-face region 3c.

### Embodiment 9

In Embodiment 8, description has been made about a case where the LEDs 6A to 6E making up the upper-illumination LED 6 are lit up simultaneously; however, in Embodiment 9, description will be made about a headlight in which each of the LEDs 6A to 6E is lit up and lit off individually.

FIG. 25 is a diagram illustrating an optical system of a projector-type headlight for driving light according to Embodiment 9, in which shown at FIG. 5(a) is a plan view of respective light-emitting faces A to J of the passing-purpose LED 1 (LEDs 1F to 1J) and the upper-illumination LED 6 (LEDs 6A to 6E), as viewed from the convex lens 2-side, and shown at FIG. 25(b) is its side view. Note that, in FIG. 25, the same reference numerals are given for the same or equivalent parts in FIG. 1 to FIG. 24, so that their description is omitted here. In Embodiment 9, for the LEDs 6A to 6E to be lit up and lit off individually, the partitioning mirror reflectors 11-1 to 11-4 that partition the respective LEDs are placed.

FIG. 26 is a diagram illustrating a positional relationship between the mirror reflector 3 and the partitioning mirror reflectors 11-1 to 11-4. Both surfaces of the partitioning mirror reflector 11-1 are reflection faces, so that the light emitted by the LED 6A is reflected on one of the reflection faces and the light emitted by the LED 6B is reflected on the other of the reflection faces. Namely, the light emitted by each LED and entering into each compartment sandwiched by the mirror reflectors at its both sides, is brought toward its exit side (opening portion) while being reflected on both reflection faces. Further, an end portion of the mirror reflector 3 in the side nearer to the convex lens 2 is placed near the rear focal point FL2 of the convex lens 2, and an edge portion of the partitioning mirror reflector 11-1 in the convex lens 2-side (opening portion) is placed in the side of the upper-illumination LED 6 and behind the end portion of the mirror reflector 3 in the convex lens 2-side. The partitioning mirror reflectors 11-2 to 11-4 are placed in the same fashion.

Namely, because the edge portion of the mirror reflector 3 in the convex lens 2-side that forms the cut-off line is placed near the rear focal point FL2 of the convex lens 2, and the edge portions in the convex lens 2-side (opening portions) of the partitioning mirror reflectors 11-1 to 11-4 that form outlines of illumination light by the LEDs 6A to 6E, are placed away from and behind the rear focal point FL2 of the convex lens 2, parallel light that forms the cut-off line is radiated by the convex lens 2, so that real images of the shapes of the partitioning mirror reflectors at the opening portions are projected. Accordingly, the outlines of the opening portions of the partitioning mirror reflectors 11-1 to 11-4 for the LEDs 6A to 6E which are projected through the convex lens 2, that is, the outlines of the respective illumination light, become clear.

In FIG. 27, there is shown a condition of illumination light radiated ahead of the vehicle in the case where the LED 6D is lit off and the other LEDs 1F to 1J and LEDs 6A to 6C and 6E are all lit up. By partitioning the light-emitting faces A to E of the LEDs 6A to 6E by the partitioning mirror reflectors 11-1 to 11-4, the respective outlines of the illumination light (A to E in FIG. 27) by the LEDs 6A to 6E become clear.

Note that in Embodiment 9, there is provided a configuration in which the partitioning mirror reflectors 11-1 to 11-4 are used for making clear the respective outlines of the illumination light by the LEDs 6A to 6E; however, this configuration is not limitative. As has been described with reference to FIG. 13 and FIG. 14 in Embodiment 3, when the light guide member 8 is provided in the upper side of the optical axis and in the convex lens 2-side of the mirror reflector 3, the partitioning mirror reflectors 11-1 to 11-4 are placed away from and behind the convex lens 2 according to the thickness of the light guide member 8, so that the respective outlines of the light-emitting faces A to E of the upper-illumination LED 6 can be projected clearly. Thus, with the use of the light guide member 8, the configuration in FIG. 13 and FIG. 14 becomes comparable to that of the case where the end portions of the partitioning mirror reflectors 11-1 to 11-4 are placed in the rear side as in Embodiment 9.

Meanwhile, in FIG. 25 to FIG. 27, the LEDs 1F to 1J and the LEDs 6A to 6E are respectively arranged in a single lateral line; however, they may be arranged with a displacement in up-down direction to be conformed to the shape of the mirror reflector 3 as in Embodiment 8.

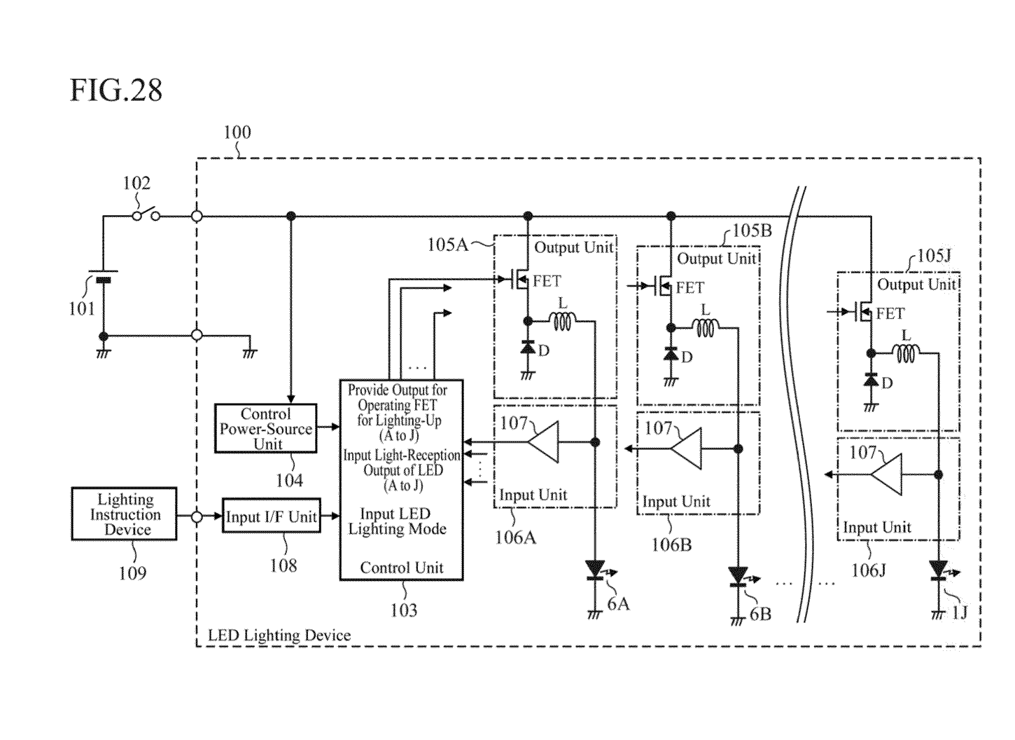

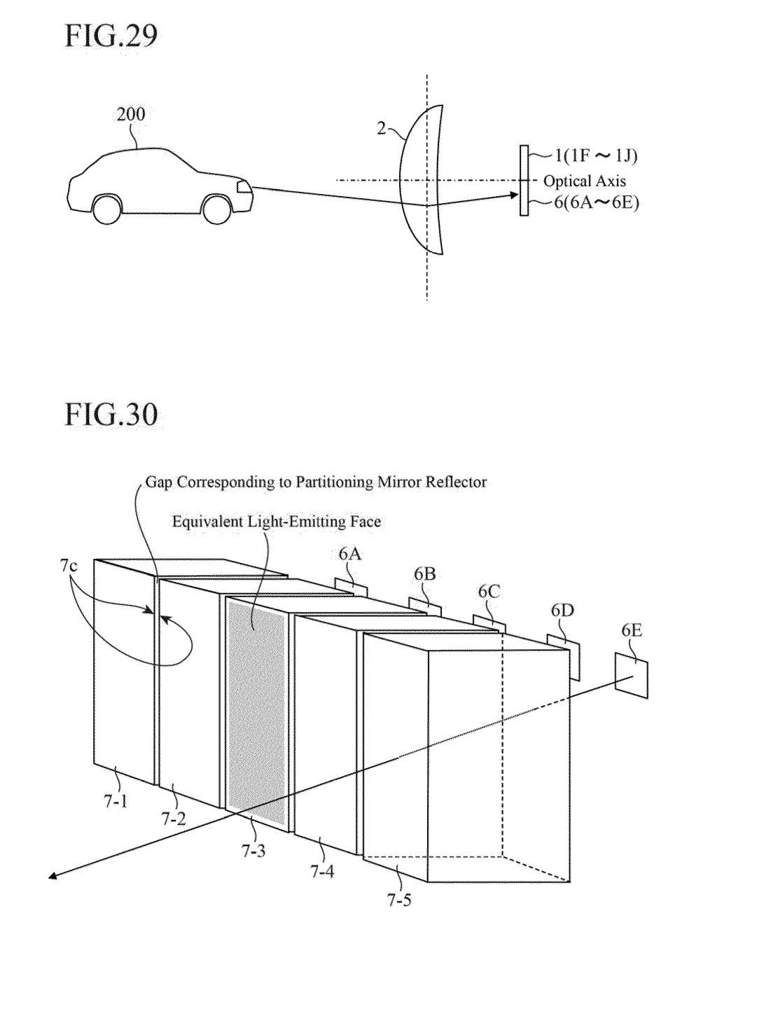

Here, an example of a circuit configuration of an LED lighting device for individually lighting up and lighting off the LEDs 6A to 6E placed below the optical axis, will be described. FIG. 28 is a circuit diagram of the LED lighting device that controls lighting of the headlight according to Embodiment 9. Further, FIG. 29 is a diagram illustrating a condition where light emitted by an oncoming vehicle 200 enters into the optical system of the headlight according to Embodiment 9.

In this example, an LED's characteristic of generating a voltage according to its ambient brightness is utilized, so that the LEDs 6A to 6E are used not only as light-emitting elements, but also as light-receiving elements. For example, as shown in FIG. 29, when any of the LEDs 6A to 6E of the headlight of the host vehicle received the light emitted by a headlight of the oncoming vehicle 200, the voltage generated by the LED that received the light changes to be higher. Thus, if the LED that received the light is not lit up, it never emits light toward the headlight of the oncoming vehicle. Namely, it is possible to achieve a headlight by which the driver driving the oncoming vehicle 200 is never dazzled.

Of course, during lighting up the LED, that is, at the time of applying voltage thereto, it is unable to get a voltage change by illuminating it from the outside with light. Thus, the above operation is performed after the lit-up LEDs are each instantaneously lit off so as to be in a condition as a light-receiving element. With respect to the LED that detected brightness due to the oncoming vehicle 200 to become higher in its voltage during such a lighting-off operation, if no lighting-up operation is given therefor (when it is lit off) at the time the LEDs are to be lit up again, this results in the aforementioned operation.

The LED lighting device 100 is a device for lighting up the passing-purpose LED 1 (LEDs 1F to 1J) and the upper-illumination LED 6 (LEDs 6A to 6E), utilizing a DC voltage of an in-vehicle power source 101, which includes: a control unit 103; a control power-source unit 104; output units 105A to 105J for supplying power to the LEDs 6A to 6E and 1F to 1J; input units 106A to 106J for inputting the voltage generated when each of the LEDs 6A to 6E and 1F to 1J receives light, to the control unit 103; and an input interface (hereinafter, I/F) unit 108. The in-vehicle power source 101 is a power source for supplying a DC voltage to the LED lighting device 100, and the DC voltage is supplied to or shut off from the LED lighting device 100 by a lighting switch 102. Further, a lighting instruction device 109 in the vehicle-side is connected to the LED lighting device 100, by which an order for the LED lighting mode (driving light and passing light) is input to the control unit 103 through the input I/F unit 108.

The control unit 103 is activated upon receiving power supply from the control power-source unit 104 and, when a lighting-up order for driving light is inputted from the lighting instruction device 109 through the input I/F unit 108, provides outputs for operating FET for lighting-up to the output units 105A to 105J so that power is fed from the output units 105A to 105J to the LEDs 6A to 6E and 1F to 1J, to thereby light up these LEDs. Meanwhile, when a lighting-up order for passing light is inputted from the lighting instruction device 109 through the input I/F unit 108, the control unit 103 provides outputs for operating FET for lighting-up to the output units 105F to 105J so that power is fed from the output units 105F to 105J to the LEDs 1F to 1J, to thereby light up these LEDs.

The output units 105A to 105J are each configured with a switching element FET (MOS-type Field Effect Transistor), a coil L and a diode D. When the switching element FET performs switching operation in response to the output for operating FET for lighting-up from the control unit 103, a current flows through the coil L to store magnetic energy therein at the on-time of the switching element, and then, the magnetic energy emerges as a current which flows toward the LED through the diode D at the off-time of the switching element. By repeating such switching operation, power for lighting up the LED is generated from a DC power supply in the in-vehicle power source 101, and outputted to each of the LEDs 6A to 6E and 1F to 1J.

When the LEDs 6A to 6E and 1F to 1J are used as light-receiving elements, the input units 106A to 106J amplify the voltages of the LEDs 6A to 6E and 1F to 1J by the amplifiers 107, respectively, to input them to the control unit 103.

When the LEDs 6A to 6E and 1F to 1J are used as light-receiving elements, the control unit 103 controls the output units 105A to 105J to temporarily suspend power feeding to the LEDs 6A to 6E and 1F to 1J, and determines occurrence or absence of light reception on the basis of the voltages inputted from the input units 106A to 106J, during suspension of power feeding. Based on the determination result, the control unit 103 controls the output unit of the LED that received light, to suspend power feeding so as to light off that LED. Note that, in this example, among the LEDs 6A to 6E and 1F to 1J, the LEDs 6A to 6E making up the upper-illumination LED 6 are assumed to be used as light-receiving elements, and the control unit 103 lights off the LEDs 6A to 6E for an extremely short time (for example, 1 msec lighting-off for 1 sec lighting-up), and determines occurrence or absence of light reception for each position of the LEDs 6A to 6E. Further, during determining that the LED 6D receives light from the oncoming vehicle 200, for example, an order for lighting-off is issued from the control unit 103 to the output unit 105D (or an order for lighting-up is not issued thereto). Note that the determination of occurrence or absence of light reception is made during an extremely short time of lighting-off period that is unlikely to be recognized by the driver's eyes (for example, 1 msec lighting-off for 1 sec lighting-up). Further note that, if the determination of occurrence or absence of light reception is made while alternately lighting off the left and right headlights of the vehicle, such lighting-off operations becomes more unlikely to be recognized by the driver.

Note that in the above description, the partitioning mirror reflectors 11-1 to 11-4 are used in order to make clear the outlines of the illumination light at the time of lighting up or lighting off the LEDs 6A to 6E individually; however, they can also be replaced with the light guide member.

FIG. 30 is a diagram illustrating a modified example of the optical system of the headlight according to Embodiment 9, in which the LEDs 6A to 6E making up the upper-illumination LED 6 are placed in the lower side of the optical axis, and light guide members 7-1 to 7-6 are placed at the positions opposite to the respective light-emitting faces of the LEDs 6A to 6E. By providing a gap between the adjacent light guide member 7-1 and light guide member 7-2, it is possible to cause their opposing side faces 7c to function as reflection faces of the partitioning mirror reflectors 11-1 to 11-4. The same applies to the light guide members 7-2 to 7-5. Accordingly, the respective light emitted by the LEDs 6A to 6E enter into the opposing light guide members 7-1 to 7-5, and are brought in a direction toward the unshown convex lens 2 while being reflected on the side faces 7c. On the respective outgoing faces of the light guide members 7-1 to 7-5 (faces opposite to the convex lens 2), equivalent light-emitting faces that are clearly compartmented are formed.

In such a manner, a thin layer of air between the opposing side faces 7c can be utilized as a partition, so that a much thinner partition can be achieved than the partition by the partitioning mirror reflectors 11-1 to 11-4.

Note that in FIG. 30, the light guide members 7-1 to 7-5 each having a rectangular parallelepiped shape are used; however, each light guide member 7-1 to 7-5 may have any shape so long as it is a shape whose side faces 7c can be used as reflection faces. For example, if the light guide member 7-1 to 7-5 is configured to have a shape that is narrow in its incident-face side but is wide in its outgoing-face side and thus includes the side faces 7c constituting inclined faces as in a horn (truncated pyramid), an angle of the incident light (light entered in the light guide member) relative to a reflection face (internal reflection face) becomes an acute angle even near the incident face (a face where the light of LED is taken in the light guide member), so that the incident light is reflected efficiently on the side faces 7c. Namely, when a horn (truncated pyramid)-like light guide member is used, reflection of light on the side faces 7c becomes more effective and thus the light emitted by the LEDs can be efficiently brought toward the outgoing side of the light guide members, so that it is possible to brightly illuminate ahead of the vehicle.

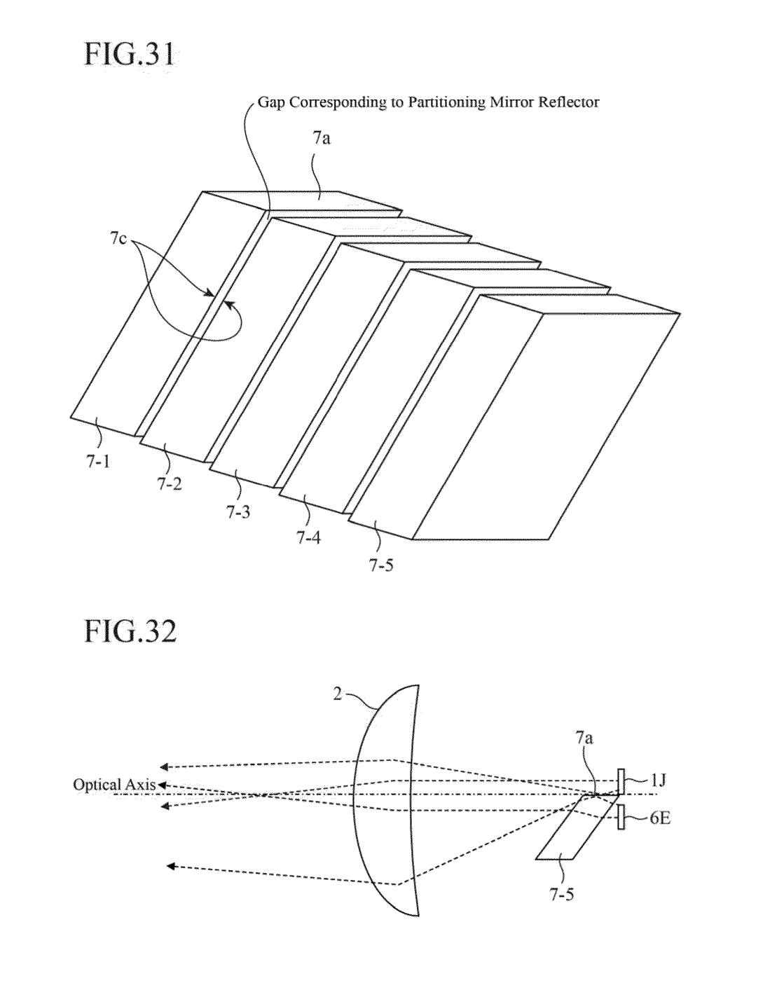

Furthermore, as shown in FIG. 31, it is allowable to form the upper faces 7a of the light guide members 7-1 to 7-5 to be parallel to the optical axis of the headlight and to form the incident faces and the outgoing faces to be inclined relative to a direction perpendicular to the optical axis. In FIG. 32, there is shown a condition of the optical system of the headlight using this light guide members 7-1 to 7-5, as viewed from the lateral side of the passing-purpose LED 1 (LEDs 1F to 1J) and the upper-illumination LED 6 (LEDs 6A to 6E). The light guide members 7-1 to 7-5 can compensate an offset of the upper-illumination LED 6 (LEDs 6A to 6E) to thereby bring the light emitted by the upper-illumination LED 6 toward the optical axis, while reflecting the light emitted by the passing-purpose LED 1 (LEDs 1F to 1J) at the upper faces 7a of the light guide members 7-1 to 7-5.

Consequently, according to Embodiment 9, there is provided a configuration in which the light-emitting face of the upper-illumination LED 6 is compartmented into a plurality of compartments, and lighting-up and lighting-off are made for each of the compartments. Thus, it is possible to achieve a light source for headlight that radiates light to any portion in front of the vehicle.

Further, according to Embodiment 9, there is provided a configuration in which an light-emitting element (for example, LED) that can be used as a light-receiving element is used for the light source for headlight, and the light-emitting elements that detected light reception is lit off. Thus, it is possible to achieve a headlight that does not radiate light in an oncoming vehicle-existing direction even during lighting driving light, namely, does not dazzle the driver driving the oncoming vehicle, without separately providing an optical sensor.

### Embodiment 10

In Embodiments 1 to 9, an LED is used as the optical source; however, in Embodiment 10, description will be made about a case of using an optical source that is configured to emit light by exciting a fluorescent material.

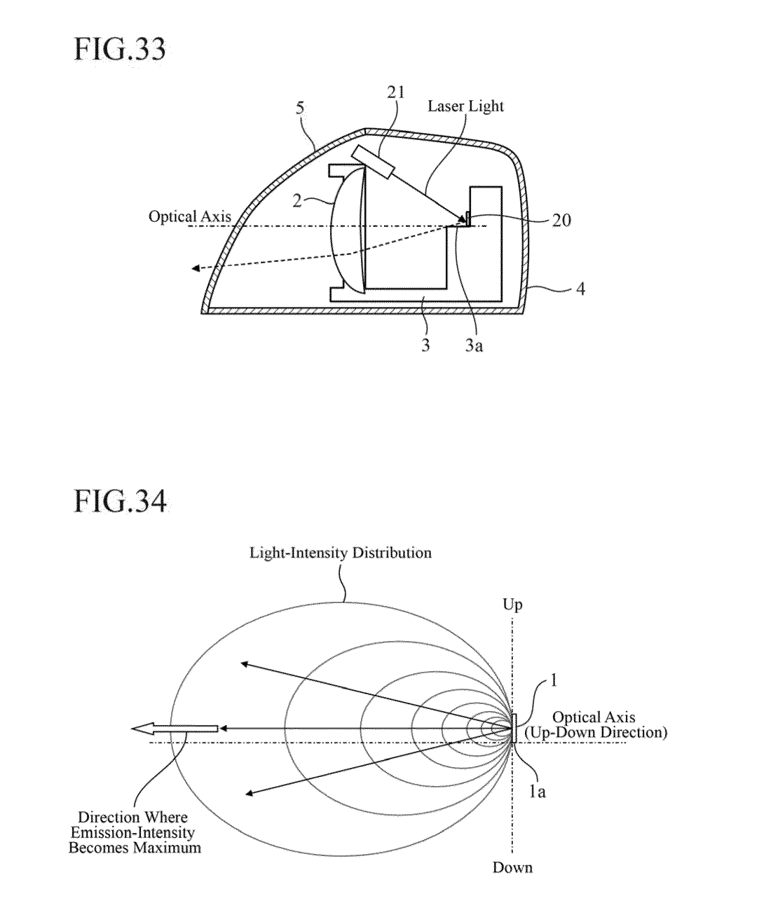

FIG. 33 is a cross-sectional view showing a configuration of a passing-purpose projection-type headlight according to Embodiment 10, in which the same reference numerals are given for the same or equivalent parts in FIG. 1 to FIG. 32, so that their description is omitted here. In the headlight according to Embodiment 10, a light-emitting face of a fluorescent member 20 is placed perpendicular to the optical axis, and laser light is radiated from a laser oscillator 21 toward the light-emitting face of the fluorescent member 20. Alternatively, instead of using the laser oscillator 21, blue light emitted by a blue LED may be radiated toward the fluorescent member 20, or an electron beam or an electromagnetic wave may be radiated toward the fluorescent member 20. A shape of an edge side 20a of the light-emitting face of the fluorescent member 20 is formed into a linear shape, and this edge side 20a is placed on the optical axis, and the reflection face 3a of the mirror reflector 3 is formed to be placed on the optical axis. Even in the case where the optical source is configured with the laser oscillator 21, its laser light and the fluorescent member 20 as described above, it is possible to enhance light emitted in the normal direction from the edge side 20a of the fluorescent member 20, so that the cut-off line becomes clear.

Note that in FIG. 33, the mirror reflector 3 is modified so that it is configured to serve as both a heat sink of the fluorescent member 20 and a support member of the convex lens 2 and the laser oscillator 21.

Further, in FIG. 33, the laser oscillator 21 and the fluorescent member 20 are placed above the optical axis to thereby configure passing light; however, this is not limitative, and it is also allowable to further place the laser oscillator 21 and the fluorescent member 20 below the optical axis to thereby configure driving light in combination with the passing light.

Consequently, according to Embodiment 10, the light source for headlight is configured to emit light by exciting the light-emitting face formed by the fluorescent member 20. Thus, an excitation portion (laser oscillator 21) and a light-emitting face (fluorescent member 20) can be placed separately, so that it is possible to mitigate heat generation to be generated by the respective parts in comparison with the LED in which an excitation portion and a light-emitting face are unified.

Note that the headlights according to Embodiments 1 to 10 are not only used as headlamps, but also usable as auxiliary lamps, such as spot lamps, fog lamps and the like for supplementing light distribution and brightness of the headlamps.

Other than the above, unlimited combination of the respective embodiments, modification of any configuration element in the embodiments and omission of any configuration element in the embodiments may be made in the present invention without departing from the scope of the invention.

### INDUSTRIAL APPLICABILITY

As described above, according to the light source for head light in accordance with the invention, an intensity of light emitted in the normal direction from the edge side of the light-emitting face is enhanced. Thus, the light source is suited to be used, for example, as a light source for a projector-type headlight in which a light-emitting face is placed perpendicular to the optical axis to thereby project light ahead of a vehicle.

### DESCRIPTION OF REFERENCE NUMERALS AND SIGNS

1: (passing purpose) LED, 1F to 1J, 6A to 6E: LEDs, 1a, 6a: edge side, 2, 2a to 2c: convex lenses, 3: mirror reflector, 3a, 3b: reflection faces, 4: casing, 5: front lens, 6: upper-illumination LED, 7, 7′, 7″, 8: light guide members, 7a: upper face, 7b: reflection face, 7c: side face, 9,10: auxiliary mirror reflectors, 11-1 to 11-4: partitioning mirror reflectors, 20: fluorescent member, 21: laser oscillator, 30: support member, 100: LED lighting device, 101: in-vehicle power source, 102: lighting switch, 103: control unit, 104: control power-source unit, 105A to 105J: output units, 106A to 106J: input units, 107: amplifier, 108: input I/F unit, 109: lighting instruction device, 200: oncoming vehicle.

1.-18. (canceled)

19. A light source for headlight which projects light emitted from a light-emitting face placed perpendicular to an optical axis of a headlight, ahead of a vehicle through a convex lens, comprising:
an optical source provided with the light-emitting face whose edge side is formed into a linear shape and placed apart from the optical axis;
a reflection face that is provided in a plane formed by a line parallel to the optical axis and a line parallel to the edge side with the linear shape of the light-emitting face and placed between the optical axis and the light-emitting face, and that reflects the light emitted from the optical source; and
a light guide member provided between the refection face and the convex lens, that brings the light emitted from the light-emitting face, closer toward the optical axis.

20. A light source for headlight which projects light emitted from a light-emitting face placed perpendicular to an optical axis of a headlight, ahead of a vehicle through a convex lens, comprising:
an optical source provided with the light-emitting face whose edge side is formed into to linear shape and placed apart from the optical axis; and
a light guide member that brings the light emitted from the light-emitting, face, closer toward the optical axis;
wherein the light guide member has a flat face corresponding to a plane that is formed by a line parallel to the optical axis and a line parallel to the edge side with the linear shape of the light-emitting face, and an inner side of the flat face is provided as a reflection face that reflects the light emitted from the optical source.

21. The light source for headlight of claim 19, wherein the reflection face is compartmented into a region placed in an oncoming traffic lane-side of the vehicle and a region placed in a walking path-side thereof, said region placed in the oncoming traffic lane-side being configured lower than the region placed in the walking path-side.

22. The light source for headlight of claim 19, wherein the light-emitting face of the optical source is placed upward from the optical axis.

23. The light source for headlight of claim 19, wherein the light-emitting face of the optical source is placed downward from the optical axis.

24. The light source for headlight of claim 19, wherein the light-emitting fare of the optical source comprises faces respectively placed upward and downward from the optical axis.

25. The light source for headlight of claim 19, wherein the light-emitting face of the optical source is compartmented into a plurality of compartments, and lighting-up and lighting-off are made for each of the compartments.

26. The light source for headlight of claim 20, wherein an outer side of the flat face of the light guide member is provided as a reflection face that reflects the light emitted from the optical source.

27. The light source for headlight of claim 19, wherein an outgoing face of the light guide member through which the light emitted from the optical source goes out, is inclined relative to a plane perpendicular to the optical axis.

28. The light source for headlight of claim 27, wherein an incident face of the light guide member on which the light emitted from the optical source is incident and the outgoing face are parallel to each other.

29. The light source for headlight of claim 27, wherein the outgoing face of the light guide member is inclined relative to an incident face thereof on which the light emitted from the optical source is incident.

30. The light source for headlight of claim 27, which comprises a second reflection face that reflects the light having been emitted from the optical source and reflected on an incident face of the light guide member, toward that incident face.

31. The light source for headlight of claim 19, wherein the light guide member includes: an incident face on which the light emitted from the optical source is incident; a second inner reflection face that reflects the incident light inside the light guide member; and an outgoing face through which the light reflected on the second inner reflection face goes out.

32. The light source for headlight of claim 19, wherein the optical source is configured to emit the light by exciting the light-emitting face formed using a fluorescent material.

33. The light source for headlight of claim 19, wherein the optical source is an LED.

34. A headlight which uses the light source for headlight described in claim 19.

35. The headlight of claim 34, wherein a light-emitting element that can be used as a light-receiving element is used in the light source for headlight, and when the light-emitting element serving also as the light-receiving element detects light incident on the headlight from an outside, the light-emitting element is not lit on.
